(19) United States
(12) Patent Application Publication
(10) Pub. No.: US 2026/0348610 A1
(43) Pub. Date: Nov. 5, 2026

(54) HEAT PUMP SYSTEMS UTILIZING MODEL PREDICTIVE CONTROL ALGORITHMS

(71) Applicant: Quilt Systems, Inc., Redwood City, CA (US)

(72) Inventors: Gwendolyn Willemijn van der Linden, Redwood City, CA (US); Matthew Aaron Knoll, Redwood City, CA (US)

(21) Appl. No.: 19/540,376

(22) Filed: Feb. 13, 2026

Related U.S. Application Data
(63) Continuation of application No. PCT/US2024/044353, filed on Aug. 29, 2024.
(60) Provisional application No. 63/538,496, filed on Sep. 14, 2023.

(51) Int. Cl. F24F 11/62; F24F 11/47; F24F 11/84; F24F 110/10; F24F 110/20; F24F 120/10; F24F 130/10

(52) U.S. Cl. CPC F24F 11/62; F24F 11/47; F24F 11/84; F24F 2110/10; F24F 2110/20; F24F 2120/10; F24F 2130/10

(57) ABSTRACT

Heat pump systems, control systems for heat pumps, and methods of controlling heat pumps are described herein that utilize system modeling algorithms for model predictive control. In one aspect, a heat pump system includes: a heat pump configured to transfer thermal energy to or from a space; multiple sensors configured to collect status information of the space; and a control system communicatively coupled with the heat pump and the sensors, where the control system is configured to: obtain a system model including a thermal model of the space; and at each of multiple time steps: receive, from the sensors, the status information at a current time step; compute, using the system model and the status information at the current time step, a control input for the heat pump at the current time step; and transmit, to the heat pump, the control input at the current time step.

### CROSS-REFERENCE TO RELATED APPLICATIONS

This application is a continuation of PCT Application No. PCT/US2024/044353, filed on Aug. 29, 2024, which claims priority to U.S. Provisional Application No. 63/538,496, filed on Sep. 14, 2023. The disclosure of the prior applications are considered part of and are incorporated by reference in the disclosure of this application.

### TECHNICAL FIELD

This specification relates generally to heat pump systems, control systems for heat pumps, and methods of controlling heat pumps that utilize system modeling algorithms for model predictive control.

### BACKGROUND

Heat pumps are devices that can perform work to transfer thermal energy from a cool space to a warm space using a thermodynamic cycle.

Heat pumps are energy efficient and environmentally friendly, as they can provide more heating and cooling energy than the electrical energy they consume. They are commonly used for space heating, cooling, and water heating in residential and commercial buildings.

### SUMMARY

This specification describes heat pump systems, control systems for heat pumps, and methods of controlling heat pumps that utilize system modeling algorithms for model predictive control.

In general, the heat pump systems described herein include a set of one or more heat pumps, multiple sensors, and a control system for controlling the set of heat pumps based on status information collected by the sensors.

The set of heat pumps is configured to transfer thermal energy between an outdoor space and each of one or more indoor spaces. Each heat pump can include: (i) one or more indoor units (IDUs) for transferring thermal energy to or from one or more of the indoor space(s), and (ii) an outdoor unit (ODU) for transferring thermal energy to or from the outdoor space. A single-zone heat pump is a heat pump that includes a single IDU and an ODU for heating or cooling a single indoor space. A multi-zone heat pump is a heat pump that includes multiple IDUs and an ODU for heating or cooling multiple indoor spaces (or multiple zones of one or more indoor spaces). A heat pump can be configured to transfer heat from the ODU to the IDU(s), and vice versa, by circulating a working fluid (e.g., a refrigerant or gas) in a thermodynamic cycle (e.g., a vapor-compression or gas cycle), thereby heating or cooling the indoor space(s) according to a control sequence performed by the control system.

The sensors are configured to collect status information of each of the indoor space(s), e.g., data characterizing a respective temperature, humidity, and occupancy of each indoor space. The sensors can also be configured to collect status information of the outdoor space, e.g., data characterizing an ambient temperature and humidity of the outdoor space. The sensors can also be configured to collect status information of the set of heat pumps, e.g., data characterizing a respective temperature, pressure, and flow rate of the working fluid at each of one or more different thermodynamic positions in the thermodynamic cycle implemented by each heat pump.

Based on the status information collected by the sensors, the control system uses a system model including a thermal model of the indoor space(s) to compute an optimal control sequence for the set of heat pumps. For example, at each time step in the control sequence, the control system can compute an optimal control input for the set of heat pumps that includes an optimal speed of each heat pump in the set, e.g., including compressor and fan speeds of the heat pump. The system model can also include a performance model of the set of heat pumps to optimize energy use and heat output of the set of heat pumps throughout a control sequence. The system model can further include an output model of the heat pump system to optimize towards a generic target, such as a respective “comfort level” of each of the indoor space(s), e.g., corresponding to a weighted combination of the temperature and humidity of the indoor space. By implementing an appropriate cost function over a prediction horizon, the control system can execute a model predictive control algorithm to determine the optimal control sequence that satisfies several desired features simultaneously, such as maximizing the efficiency of the set of heat pumps, tracking a temperature, humidity, and/or occupancy schedule, minimizing fluctuations in the temperature and/or humidity (e.g., for occupant comfort), reducing energy costs (e.g., due to peak pricing), adapting to weather forecasts, controlling for noise of the set of heat pump, among other features.

These and other features related to the heat pump systems, control systems for heat pumps, and methods of controlling heat pumps described herein are summarized below.

In a first aspect, a heat pump system is described. The heat pump system includes: a heat pump configured to transfer thermal energy to or from a space in accordance with a respective control input at each of multiple time steps; multiple sensors configured to collect status information of the space over the time steps; and a control system communicatively coupled with the heat pump and the sensors. The control system is configured to: obtain a system model including a thermal model of the space, where the thermal model characterizes a state of the space at a sequential time step in response to: (i) a state of the space at a given time step, and (ii) a given control input for the heat pump at the given time step; and at each of the time steps: receive, from the sensors, the status information at a current time step; determine, from the status information at the current time step, a state of the space at the current time step; predict, using the thermal model, a respective state of the space at each of one or more future time steps in response to: (i) the state of the space at the current time step, and (ii) a respective given control input for the heat pump at each of the current and future time steps; generate a cost function that depends on the states of the space and given control inputs at each of the current and future time steps; minimize the cost function with respect to the given control inputs at each of the current and future time steps to determine the control input at the current time step; and transmit, to the heat pump, the control input at the current time step.

In some implementations of the heat pump system, at each of the time steps, the cost function includes, for each of the current and future time steps, a respective cost term that depends on the respective state of the space and given control input at the current or future time step.

In some implementations of the heat pump system, each cost term includes: (i) a respective first cost term that depends on the respective state of the space at the current or future time step, and (ii) a respective second cost term that depends on the respective given control input at the current or future time step.

In some implementations of the heat pump system, the control system is further configured to receive a reference state trajectory including a respective reference state of the space for each of the time steps, and each first cost term includes a respective error between: (i) the respective state of the space, and (ii) the respective reference state of the space, at the current or future time step.

In some implementations of the heat pump system, the reference state trajectory includes one or more of: a temperature schedule including a respective setpoint temperature of the space for each of the time steps; a humidity schedule including a respective setpoint humidity of the space for each of the time steps; or an occupancy schedule including a respective expected occupancy of the space for each of the time steps.

In some implementations of the heat pump system, the control system is further configured to receive a reference control sequence including a respective reference control input for each of the time steps, and each second cost term includes a respective error between: (i) the respective given control input, and (ii) the respective reference control input, at the current or future time step.

In some implementations of the heat pump system, at each of the time steps, the cost function further includes a terminal cost term that depends on the state of the space at a terminal future time step.

In some implementations of the heat pump system, the sensors include: a temperature sensor configured to collect status information characterizing a temperature of the space; a humidity sensor configured to collect status information characterizing a humidity of the space; and a presence sensor configured to collect status information characterizing an occupancy of the space, and a state of the space at a given time step includes: (i) a temperature of the space, (ii) a humidity of the space, and (iii) an occupancy of the space, at the given time step.

In some implementations of the heat pump system, the presence sensor is a millimeter-wave (mmWave) sensor, a thermal imaging sensor, a passive infrared (PIR) sensor, a light detection and ranging (LIDAR) sensor, a carbon dioxide (CO₂) sensor, a window sensor, a door sensor, or a connected Internet of things (IoT) sensor.

In some implementations of the heat pump system, the space is an indoor space, and the thermal model includes: a thermal capacitance of the indoor space; and a net thermal energy transfer rate between the heat pump and the indoor space.

In some implementations of the heat pump system, the thermal model further includes, for each of multiple spaces that are adjacent to the indoor space, a respective thermal coupling between the indoor space and the adjacent space.

In some implementations of the heat pump system, for each of the adjacent spaces, the respective thermal coupling includes a respective thermal resistance between the indoor space and the adjacent space.

In some implementations of the heat pump system, the thermal model further includes: a mass of air residing in the indoor space; and a mass flow rate of air expelled from the heat pump into the indoor space.

In some implementations of the heat pump system, for each of one or more of the adjacent spaces, the respective thermal coupling further includes a respective mass flow rate of air between the indoor space and the adjacent space.

In some implementations of the heat pump system, one of the adjacent spaces is an outdoor space.

In some implementations of the heat pump system, the thermal model further includes a net solar thermal energy transfer rate between the outdoor space and the indoor space.

In some implementations of the heat pump system, the space is an indoor space, the heat pump is configured to transfer thermal energy between the indoor space and an outdoor space in accordance with the respective control input at each of the time steps, the sensors are further configured to collect status information of the outdoor space over the time steps, and the control system is further configured to, at each of the time steps: determine, from the status information at the current time step, a state of the outdoor space at the current time step; and update a set of model parameters of the thermal model for the current time step based on the state of the outdoor space at the current time step.

In some implementations of the heat pump system, the sensors include: a temperature sensor configured to collect status information characterizing an ambient temperature of the outdoor space; and a humidity sensor configured to collect status information characterizing an ambient humidity of the outdoor space, and a state of the outdoor space at a given time step includes: (i) an ambident temperature of the outdoor space, and (ii) an ambient humidity of the outdoor space, at the given time step.

In some implementations of the heat pump system, the control system is further configured to: receive a weather forecast including a respective predicted state of the outdoor space for each of the time steps; and at each of the time steps, predict a respective set of model parameters of the thermal model for each of the one or more future time steps based on the respective predicted state of the outdoor space at the future time step.

In some implementations of the heat pump system, at each of the time steps, predicting, using the thermal model, the respective state of the space at each of the one or more future time steps includes: receiving an input including the state of the space and given control input at a time step that precedes the future time step; and processing the input using the thermal model, in accordance with the set of model parameters for the time step that precedes the future time step, to predict the state of the space at the future time step.

In some implementations of the heat pump system, the heat pump is configured to circulate a working fluid in a thermodynamic cycle, the heat pump including: a variable-speed compressor configured to compress the working fluid; an indoor heat exchanger configured to transfer thermal energy between the working fluid and the indoor space; and an outdoor heat exchanger configured to transfer thermal energy between the working fluid and the outdoor space, and the respective control input includes, at each of the time steps: a respective speed of the compressor at the time step; a respective speed of a fan of the indoor heat exchanger at the time step; and a respective speed of a fan of the outdoor heat exchanger at the time step.

In some implementations of the heat pump system, the working fluid is a refrigerant, and the thermodynamic cycle is a vapor-compression cycle.

In some implementations of the heat pump system, the working fluid is a gas, and the thermodynamic cycle is a gas cycle.

In some implementations of the heat pump system, the heat pump further includes: an electronic expansion valve configured to expand the working fluid; and a reversing valve configured to reverse a direction of the working fluid circulating in the heat pump, and the respective control input further includes, at each of the time steps: a respective size of an opening of the electronic expansion valve at the time step; and a respective energized or de-energized state of the reversing valve at the time step.

In some implementations of the heat pump system, the sensors are further configured to collect status information of the working fluid at each of one or more thermodynamic positions in the thermodynamic cycle over the time steps.

In some implementations of the heat pump system, the sensors include: one or more temperature sensors configured to collect status information characterizing a respective temperature of the working fluid at each of the one or more thermodynamic positions in the thermodynamic cycle; and one or more pressure sensors configured to collect status information characterizing a respective pressure of the working fluid at each of the one or more thermodynamic positions in the thermodynamic cycle.

In some implementations of the heat pump system, the heat pump includes: an indoor unit housing the indoor heat exchanger and one or more of the sensors; and an outdoor unit housing the compressor, outdoor heat exchanger, reversing valve, and one or more of the sensors.

In some implementations of the heat pump system, the electronic expansion valve is housed in the indoor or outdoor unit.

In some implementations of the heat pump system, at least a portion of the control system is housed in the indoor unit, the outdoor unit, or both.

In some implementations of the heat pump system, the control system includes one or more local control devices each housed in the indoor or outdoor unit.

In some implementations of the heat pump system, the control system further includes a main control device communicatively coupled with the one or more local control devices.

In some implementations of the heat pump system, the system model further includes a performance model of the heat pump, where the performance model characterizes a set of performance metrics of the heat pump at a given time step in response to a given control input for the heat pump at the given time step, the control system is further configured to, at each of the time steps, predict, using the performance model, a respective set of performance metrics of the heat pump at each of the current and future time steps in response to the respective given control input at the current or future time step, and at each of the time steps, the cost function depends on the sets of performance metrics of the heat pump at each of the current and future time steps.

In some implementations of the heat pump system, the control system is further configured to, at each of the time steps, update a set of model parameters of the performance model for the current time step based on the states of the indoor and outdoor spaces at the current time step.

In some implementations of the heat pump system, the control system is further configured to, at each of the time steps, predict a respective set of model parameters of the performance model for each of the one or more future time steps based on: (i) the respective state of the indoor space at the future time step, (ii) the respective predicted state of the outdoor space at the future time step, or (iii) both.

In some implementations of the heat pump system, at each of the time steps, predicting, using the performance model, the respective set of performance metrics of the heat pump at each of the current and future time steps includes: receiving an input including the given control input at the current or future time step; and processing the input using the performance model, in accordance with the set of model parameters for the current or future time step, to predict the set of performance metrics of the heat pump at the current or future time step.

In some implementations of the heat pump system, a set of performance metrics of the heat pump at a given time step includes: (i) a net thermal energy transfer rate of the heat pump, and (ii) a power consumption of the heat pump, at the given time step, the control system is further configured to, at each of the time steps, predict a respective coefficient of performance of the heat pump at each of the current and future time steps based on a ratio between: (i) the respective net thermal energy transfer rate of the heat pump, and (ii) the respective power consumption of the heat pump, at the current or future time step, and at each of the time steps, the cost function depends on the coefficients of performance of the heat pump at each of the current and future time steps.

In some implementations of the heat pump system, the control system is further configured to receive a peak pricing schedule including a respective predicted price of energy for each of the time steps, and at each of the time steps, the cost function includes, for each of the current and future time steps, a respective energy cost term that depends on the respective power consumption of the heat pump multiplied by the respective predicted price of energy at the current or future time step.

In some implementations of the heat pump system, the system model further includes an output model of the heat pump system, where the output model characterizes a system output of the heat pump system at a given time step in response to a state of the space at the given time step, the control system is further configured to, at each of the time steps, predict, using the output model, a respective system output of the heat pump system at each of the current and future time steps in response to the respective state of the space at the current or future time step, and at each of the time steps, the cost function depends on the system outputs of the heat pump system at each of the current and future time steps.

In some implementations of the heat pump system, the control system is further configured to obtain a reference system trajectory including a respective reference system output of the heat pump system for each of the time steps, and at each of the time steps, the cost function includes, for each of the current and future time steps, a respective error between: (i) the respective system output of the heat pump system, and (ii) the respective reference system output of the heat pump system, at the current or future time step.

In a second aspect, a control system for a heat pump configured to transfer thermal energy to or from a space in accordance with a respective control input at each of multiple time steps is described. The control system is configured to: obtain a system model including a thermal model of the space, where the thermal model characterizes a state of the space at a sequential time step in response to: (i) a state of the space at a given time step, and (ii) a given control input for the heat pump at the given time step; and at each of the time steps: receive, from multiple sensors configured to collect status information of the space over the time steps, the status information at a current time step; determine, from the status information at the current time step, a state of the space at the current time step; predict, using the thermal model, a respective state of the space at each of one or more future time steps in response to: (i) the state of the space at the current time step, and (ii) a respective given control input for the heat pump at each of the current and future time steps; generate a cost function that depends on the states of the space and given control inputs at each of the current and future time steps; minimize the cost function with respect to the given control inputs at each of the current and future time steps to determine the control input at the current time step; and transmit, to the heat pump, the control input at the current time step.

In some implementations, the control system includes one or more local control devices.

In some implementations, the control system further includes a main control device communicatively coupled with the one or more local control devices.

In a third aspect, a method performed by a control system for a heat pump configured to transfer thermal energy to or from a space in accordance with a respective control input at each of multiple time steps is described. The method includes: obtaining a system model including a thermal model of the space, where the thermal model characterizes a state of the space at a sequential time step in response to: (i) a state of the space at a given time step, and (ii) a given control input for the heat pump at the given time step; and at each of the time steps: receiving, from multiple sensors configured to collect status information of the space over the time steps, the status information at a current time step; determining, from the status information at the current time step, a state of the space at the current time step; predicting, using the thermal model, a respective state of the space at each of one or more future time steps in response to: (i) the state of the space at the current time step, and (ii) a respective given control input for the heat pump at each of the current and future time steps; generating a cost function that depends on the states of the space and given control inputs at each of the current and future time steps; minimizing the cost function with respect to the given control inputs at each of the current and future time steps to determine the control input at the current time step; and transmitting, to the heat pump, the control input at the current time step.

Particular embodiments of the subject matter described in this specification can be implemented so as to realize one or more of the following advantages.

In current trends, variable-speed heat pumps are increasingly used for heating and cooling spaces in a residence. They provide a more efficient means to heat a home compared to existing fuel-based systems. For cooling, they can improve upon the efficiency of existing single- or two-speed air conditioning (AC) systems. Also, ductless heat pump systems and multi-zone heat pump systems can provide dedicated conditioning for each space, allowing independent temperature control.

A notable property of variable-speed heat pumps is that their efficiency depends on the compressor speed, indoor and outdoor temperature and humidity, and the fan speeds of the indoor units (IDUs) and outdoor unit (ODU) of the heat pump. Typically, running a heat pump system at full capacity or too low of capacity is less efficient (e.g., as measured by the thermal output as a function of energy use). Ductless heat pump systems can have multiple IDUs connected to a single ODU, such that the efficiency of one IDU depends on the operation and conditions of the other IDUs. Additionally, ODUs typically have a minimum capacity they should (or need) to run at—when a lower capacity is specified, they often need to ‘short-cycle’ (e.g., turn the heat pump system on and off periodically to push the mean capacity below the minimal capacity), which decreases energy efficiency. Furthermore, the amount of heating or cooling involved for a specific residence is different for each residence and the spaces within the residence. Further still, the spaces within a residence can be thermally coupled to one another. For example, aggressive heating of the downstairs rooms of a residence may cause overheating of the upstairs rooms of the residence.

Existing heat pump systems generally have a basic temperature control loop that runs on low-cost, low-performance central processing units (CPUs) built into the heat pump system. The remote controls or thermostats may send a temperature setpoint to the existing temperature control loop. Third-party smart thermostats, which may have additional sensors and the computing performance to execute more sophisticated algorithms, generally do not know the specifications of the interconnected heat pump system, nor do they have real-time status information about the operation of the interconnected heat pump system. Therefore, current approaches generally do not allow for integrated smart algorithms that can proactively, gently, and efficiently condition spaces based on the known properties and current and future conditions of the heat pump system and the spaces being heated and cooled by the heat pump system.

Existing multi-zone residential heat pump systems generally only run in heating or cooling mode, and the user typically must manually select heating or cooling. In case an ‘auto’ mode is provided, existing heat pump systems typically select either heating or cooling based on the zone with the greatest need. They do not automatically and optimally schedule between modes to service all the connected spaces. Additionally, when more than one IDU is installed in a space, it is typically up to the user to control each of them. Existing heat pump systems generally do not automatically balance between multiple IDUs.

Furthermore, heat pump systems running in cooling mode may remove moisture from the indoor air through condensation on a condenser coil. Typically, a user needs to manually select a “drying mode” to reduce the humidity of a space. Dedicated dehumidification systems do this automatically, but existing heat pump systems designed for heating and cooling do not, even though they are physically capable of dehumidification.

Further still, the price of electricity can depend on the time of day and/or total energy consumed over a period of time (e.g., tier-based tariffs). The user of a heat pump system may wish to minimize the cost of conditioning their home. Existing heat pump systems, such as those including smart thermostats that can enroll in so-called demand-response programs, do not explicitly measure and optimize over the actual electricity used and instead apply general rules to attempt to minimize energy consumption.

Consequently, currently available heat pump systems do not run at peak efficiency nor automatically support all features. To utilize these systems to their full capability and as efficiently as possible, the burden is on the user. Users typically need to set up efficient temperature setpoint schedules for each space, adjust them as space occupancy schedules change, and override them diligently by manually adjusting the temperature setpoint depending on spaces being occupied or unoccupied outside of the schedule. Additionally, users may need to gently increase or decrease the temperature setpoint to avoid running the heat pump system at an inefficient, higher capacity. This is not a reasonable task and results in user burden, reduced energy efficiency, and/or reduced occupant comfort.

To overcome some, or all, of these abovementioned challenges, this specification introduces heat pump systems, control systems for heat pumps, and methods of controlling heat pumps that utilize system modeling algorithms for model predictive control.

The heat pump system design described in this specification can be used to efficiently and conveniently operate single-zone heat pump systems conditioning a single space (e.g., a room, office, studio, or Accessory Dwelling Unit (ADU)), or multi-zone heat pump systems conditioning multiple spaces (or multiple zones of one or more spaces), e.g., covering part or the whole of a residence. The described heat pump system design can be used to seamlessly combine more than one IDU per space, where the heat pump system balances the output of each IDU, while a user can set the desired temperature and humidity for the space, as well as an expected occupancy of the space.

The described heat pump system includes a control system integrated into the IDUs, ODUs, and/or a separate module, that is capable of running sophisticated model predictive control algorithms, is fully connected and aware of the whole heat pump system, and has rich information on the conditioned spaces and their occupancy. The heat pump system can optionally include one or more smart thermostats that can be installed in one or more of the conditioned spaces and that are fully connected and aware of the other heat pump system components. In implementations, the heat pump system can also be remotely controlled using a dedicated mobile phone app or other remote-control application.

In general, the control system is configured process the sensor signals, handle communication between the ODUs and IDUs, and run the computationally intensive model predictive control algorithms. The control system can be configured with bi-directional communication that provides complete access of control and status information to and from the IDUs' and ODUs' hardware. For example, control and status information can include commanded and actual compressor speeds, EEV (Electronic Expansion Valve) openings, and fan speeds of the IDUs and ODUs.

Sensors can be integrated into the IDUs, the ODUs, and the smart thermostats to collect the status information of the conditioned spaces, ambident conditions, and various operating conditions of the heat pumps. For example, the sensors can include: (i) indoor and outdoor temperature and humidity sensors, air intake and exhaust temperature and humidity sensors, volumetric air flow sensors, condensation flow rate sensors, refrigerant temperature and pressure sensors at various locations in the refrigerant loop; microphone, accelerometer, and other acoustic and vibration sensors; (ii) current and voltage sensors to measure the real consumed electrical power in parts or the whole of the heat pump system; (iii) presence sensors integrated into the IDUs and thermostats, (e.g., millimeter-Wave (mmW) radar sensors, thermal imaging, passive infrared (PIR), LIDAR sensors, carbon dioxide (CO₂) sensors, window and/or door sensors (opened/closed or opening angle), connected Internet of things (IoT) sensors); and (iv) connected personal device sensors, such as those integrated into mobile phones, smartwatches, and other wearable devices, that provide biometric data, e.g., heart-rate, skin temperature, oxygenation, sleep cycle, motion, and/or (geo)location.

The control system can be in communication with a cloud management system (e.g., a cloud server). The cloud management server can provide access to historical and current data of all the individual heat pump systems connected to the cloud management system, as well as control of some, or all, of the connected heat pump systems. Engineering and laboratory data about the IDUs and ODUs of the heat pump system can be made available to the control system via the cloud management system. Such data can be utilized by the control system for performing temperature feedback control, optimal predictive control, and model estimation and refinement. This data can include component specifications such as compressor performance curves, and tables or curves that yield energy consumption and thermal output as a function of various parameters for the specific combination of the IDUs and ODUs. The cloud management system can provide direct or cloud-to-cloud integration with third-party applications and hardware such as smartphones, wearable devices, and IoT devices.

The control system can be in communication with a user control device, e.g., a thermostat or mobile device, that is configured with a (e.g., graphical) user interface. The user interface can allow users to provide general or individual preferences for temperature and humidity setpoint schedules, as well as specify how the control system should tradeoff between comfort, noise, energy use, cost, and/or climate impact (e.g., estimated equivalent CO₂ output).

In general, the control systems described herein can be configured to perform one or more of the following novel aspects.

The control system can build a detailed thermal model of a space characterizing the thermal response of the space and the thermal coupling between spaces, e.g., based on the provided properties of a home, recorded history of indoor and outdoor temperatures and humidity, and weather conditions.

From the thermal model of a space, the control system can determine: (i) what amount of energy in to or out of the space is involved to maintain a temperature setpoint or follow a desired temperature schedule; (ii) how outside weather conditions (past, present, and forecasted) affect indoor conditions over time; (iii) how outdoor temperature and humidity affect temperature and humidity of the space; (iv) how wind speed and direction affect the temperature of the space; (v) how solar loading and daytime and nighttime cloud cover affect the temperature of the space; and (vi) how temperatures and humidities of the space are coupled between spaces.

The control system can use occupancy information collected from the occupant(s) about open windows and doors and other aspects that impact thermal response to enhance the thermal model. For example, the control system can use calibration modes where the control system provides instructions to the occupant(s) to open or close windows and doors, operate bathroom fans, range hood, and other aspects that impact thermal. The control system can then use the calibrated thermal model to detect open doors or windows, or fans that are running unnecessarily.

In implementations, the thermal model includes a behavioral model of one or more occupants of the space that estimates occupancy, e.g., the likelihood of the space being occupied as a function of time and other factors. The behavior model can also predict the thermal effects from activities that generate heat and moisture, such as cooking, use of appliances, and opening or closing of windows and doors. The resulting behavioral model predicts when the space is occupied and needs to be comfortable, how much additional heating and humidity loads may occur if the space becomes occupied, as well as changes in the thermal model due to changes in ventilation (e.g., exchanging air to the outdoors) and circulation of air between spaces. The control system may construct the behavior model from presence data collected from presence sensors integrated into the heat pump system, as well as other sensors integrated into user devices, e.g., including smartphone location, Wi-Fi, and/or Bluetooth signals and signal properties. The control system can also use the presence data to locate and identify individuals in a home, e.g., via the identification information received from their user devices or methods such as gait detection. The control system can build a behavioral model that is personalized for each of the occupants of a home, allowing the control system to differentiate between the occupants, automatically adjust setpoints and other settings such as maximum compressor and fan speeds, implement tradeoffs between comfort and energy consumption that are personalized to an occupant, among other features.

The control system can also build a detailed performance model of a heat pump characterizing the behavior and performance of the heat pump, e.g., based on laboratory data and field observations. The resulting performance model predicts the available thermal output and energy efficiency of the heat pump as a function of available settings and conditions, including but not limited to, ODU and IDU fan speed, compressor speed, and indoor and outdoor temperature and humidity. The control system can use cloud fleet data to build detailed performance models for the ODUs and IDUs over a large range of conditions for identical hardware.

The control system minimizes the energy consumption and/or energy costs associated with heating, cooling, and humidity control, while meeting the comfort requirements of the occupants, given the heat pump system capabilities and limitations. The control system can determine the optimal operation of the heat pump system using a model predictive control algorithm that involves measuring the current state of the heat pump system and optimizing for the future state of the heat pump system over a prediction horizon. For example, the control system can use: (i) current and historical data collected from the sensors to estimate the current state of the heat pump system; (ii) the predictive models described above and future data (e.g., a weather forecast) to predict the future state of the heat pump system; (iii) operational constraints on the heat pump system such as maximum and minimum compressor and fan speeds; (iv) imposed constraints on the heat pump such as setpoint schedules and safety requirements (e.g., to prevent the home from freezing or becoming too humid even when unoccupied); and (v) a cost function that weighs, over the prediction horizon, energy use and cost against these constraints, as well as additional soft comfort constraints (e.g., small temperature deviations, air flow speed, and noise level). Hence, the cost function can encompass a set of possible futures of the heat pump system when considering the statistical nature of some of these constraints, such as predicted occupancy and weather forecasts.

For example, a wide allowable temperature range for unoccupied spaces may afford the control system the freedom to let the temperature drift substantially. However, using the model predictive control algorithm, the control system can choose to not drift the temperature into a range that would involve inefficient high-power operation to bring the room back to a comfortable temperature when occupied. To accomplish this, the control system can predict when an unoccupied space will again be occupied, and using the thermal and performance models, can determine the optimal temperature setback profile over time that realizes maximum energy savings for the unoccupied spaces while still efficiently pre-conditioning the space at the appropriate time in anticipation of occupancy.

In general, the heat pump systems described herein can be implemented to perform one or more of the following novel aspects.

The heat pump system can be employed to keep the humidity levels in a space within a desired range, without the need for a dedicated drying mode. The detailed performance model of a heat pump also predicts the moisture removal rate of the IDU(s) as a function of uncontrollable and controllable inputs, and the control system can exploit the freedom in controllable inputs to select an operating condition that provides the desired moisture removal rate, e.g., to converge to a humidity setpoint.

The heat pump system can optimize for comfort and sleep quality of occupants by correlating information coming from systems such as wearable technology, and adjusting the setpoints for temperature, humidity, air flow, and air flow direction (e.g., louver angles).

The heat pump system can balance the operation of multiple IDUs and ODUs to produce a similar outcome as if each were operated individually, but with lower energy consumption or cost.

The heat pump system can switch between heating and cooling modes for the ODU(s) over time, to allow for heating of one space and cooling of another, without user intervention.

The heat pump system can recover some of the thermal energy stored in the heat pump system when switching between heating and cooling modes to cool one space and heat another, e.g., recover the heat stored in the outdoor heat exchanger after cooling one space.

The heat pump system can use current and future (scheduled or predicted) occupancy as an input to the model predictive control algorithms, e.g., allow for higher fan speeds that cause more noise when a space is unoccupied.

The heat pump system can use the predictive models to detect discrepancies between predicted and measured data, and detect malfunctions or other undesirable conditions such as open windows or doors or failing/malfunctioning system components. These models can be created by the control system for the specific home, or using data from several homes via the cloud infrastructure.

The heat pump system can allow and encourage users to provide temperature and humidity setpoint settings and schedules that provide a large degree of freedom for the control system to exploit for maximizing energy efficiency. The heat pump system can use the predictive models to simulate the required energy use given selected user settings, and estimate the energy consumption impact of changes in user settings. For example, the heat pump system can use patterns detected in presence data to suggest more efficient setpoint schedules, reducing the energy used to condition spaces while unoccupied. As another example, the heat pump system can suggest a more efficient allowable ‘away’ temperature range, and provide the estimated energy consumption reduction to the user, e.g., via a user interface, motivating the user to make the adjustment.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram depicting an example of a heat pump system including a set of heat pumps and a control system.

FIG. 2A is a schematic diagram depicting an example of a heat pump system including a set of heat pumps and a distributed control system.

FIG. 2B is a schematic diagram depicting another example of a heat pump system including a set of heat pumps and a distributed control system.

FIG. 2C is a schematic diagram depicting yet another example of a heat pump system including a set of heat pumps and a distributed control system.

FIG. 3A is a schematic diagram depicting an example of an outdoor unit (ODU).

FIG. 3B is a schematic diagram depicting an example of an indoor unit (IDU).

FIG. 4A is a schematic diagram depicting an example of a single-zone heat pump including an ODU and an IDU.

FIG. 4B is a schematic diagram depicting an example of a multi-zone heat pump including an ODU and multiple IDUs.

FIG. 5 is a schematic diagram depicting an example of a building configured with a heat pump system.

FIG. 6A is a schematic diagram depicting an example model of a single-zone heat pump in a heating mode.

FIG. 6B is a schematic diagram depicting an example model of a single-zone heat pump in a cooling mode.

FIG. 6C is a phase diagram depicting an example of a vapor-compression cycle that can be implemented by a heat pump.

FIG. 7A is a schematic diagram depicting an example of an indoor space configured with an IDU of a heat pump for heating or cooling the indoor space.

FIG. 7B depicts an example thermal model of the indoor space of FIG. 7A.

FIG. 8 is a flow diagram of an example process for controlling a heat pump system with a control system executing a model predictive control algorithm.

FIGS. 9A-9C include plots depicting indoor temperature and energy usage versus time for different heat pump control sequences.

Like reference numbers and designations in the various drawings indicate like elements.

### DETAILED DESCRIPTION

In recent trends, variable-speed heat pumps are increasingly being used for heating and cooling spaces in a residence. They provide a more efficient means to heat a home compared to existing fuel-based systems. For cooling, they can improve upon the efficiency of existing single- or two-speed air conditioning (AC) systems. Also, ductless heat pump systems and multi-zone heat pump systems can provide dedicated conditioning for each space, allowing independent temperature control. For reference, a “ductless heat pump system”, sometimes referred to as a “mini-split heat pump system”, is a type of heat pump system that can provide climate control for individual space or zones in a building without the need for ductwork (e.g., conduits, tubing, or other passages) which is used in conventional heating, ventilation, and air conditioning (HVAC) systems for transferring air to or from the building.

A notable property of variable-speed heat pumps is that their thermal output and efficiency depends on the compressor speed, indoor and outdoor heat exchanger fan speeds, and indoor and outdoor temperature and humidity. Typically, running a heat pump system at full capacity or too low of capacity is less efficient, e.g., as measured by the total thermal output of the heat pump system as a function of energy use, or in terms of the coefficient of performance (COP) of the heat pump system. Ductless heat pump systems can have multiple indoor units (IDUs) connected to a single outdoor unit (ODU), such that the efficiency of one IDU depends on the operation and conditions of the other IDUs. Also, ODUs typically have a minimum capacity they should (or need) to run at, e.g., about 30% of maximum capacity. When a lower capacity is desired, they often need to ‘short-cycle’, e.g., turn the heat pump system on and off periodically to push the mean capacity below the minimal capacity, which decreases energy efficiency. Moreover, the amount of heating or cooling involved for a specific residence is different for each residence and the spaces within the residence. The spaces within a residence can also be thermally coupled to one another. For example, aggressive heating of the downstairs rooms of a residence may cause overheating of the upstairs rooms of the residence. Existing heat pump systems generally do not account for these various confounding factors and, therefore, have suboptimal efficiency.

Existing heat pump systems generally have a basic temperature control loop that runs on low-cost, low-performance central processing units (CPUs) built into the heat pump system. The remote controls or thermostats may send a temperature setpoint to the existing temperature control loop. Third-party smart thermostats, which may have additional sensors and the computing performance to execute more sophisticated algorithms, generally do not know the specifications of the interconnected heat pump system, nor do they have access to real-time status information characterizing the operation of the interconnected heat pump system.

Therefore, current approaches generally do not allow for integrated smart algorithms that can proactively, gently, and efficiently condition spaces based on known properties of the heat pump system, current and future conditions of the heat pump system, and known properties of the spaces being heated and cooled by the heat pump system.

Existing multi-zone residential heat pump systems generally only run in heating or cooling mode, and a user typically must manually select heating or cooling. In situations where an ‘auto’ mode is provided, existing heat pump systems typically select either heating or cooling modes based on the zone with the greatest need. They generally do not automatically and optimally schedule between modes to service all the connected spaces. Additionally, when more than one IDU is installed in a space, it is typically up to the user to control each IDU. Existing heat pump systems generally do not automatically balance between IDUs, nor do they let the user holistically control the space.

Furthermore, heat pump systems running in cooling mode may remove moisture from the indoor air through condensation on a condenser coil, directing the condensation fluid to the outdoors. Typically, a user needs to manually select a “drying mode” to reduce the humidity of a space. Dedicated dehumidification systems do this automatically, but existing heat pump systems designed for heating and cooling do not, even though they are physically capable of dehumidification.

Further still, when considering energy usage, the price of energy (e.g., electricity) may depend on the time of day and/or total energy consumed over a period of time (e.g., tier-based tariffs). A user of a heat pump system may wish to minimize the cost of conditioning their home. Existing heat pump systems, such as those including smart thermostats that can enroll in so-called demand-response programs, do not explicitly measure and optimize over the actual energy used and instead apply general rules in attempt to minimize energy consumption. Consequently, existing heat pump systems do not run as efficiently as they could nor do they automatically support all features—to utilize these existing systems more efficiently, the burden is on the user. Users typically need to set up efficient temperature setpoint schedules for each space, adjust them as space occupancy schedules change, and override them diligently by manually adjusting the temperature setpoint when spaces become occupied (or unoccupied) outside of the occupancy schedule. Additionally, they need to gently increase or decrease the temperature setpoint to avoid running the heat pump system at an inefficient higher capacity. This is not a reasonable task, and results in user burden, reduced energy efficiency, and/or reduced comfort.

To overcome some, or all, of these abovementioned challenges, this specification introduces heat pump systems, control systems for heat pumps, and methods of controlling heat pumps that utilize system modeling algorithms for model predictive control.

The heat pump systems described herein include a set of one or more heat pumps, multiple sensors, and a control system.

Among other features, a heat pump system as described herein can be implemented so as to realize one or more of the following novel aspects.

The heat pump system can be used to maintain the humidity levels in a space within a desired range, without the need for a dedicated drying mode. For example, the control system can use a detailed thermal model of the space which predicts the moisture removal rate of an IDU as a function of controllable and uncontrollable inputs. The control system can exploit the freedom in control inputs to select an operating condition that provides the desired moisture removal rate, e.g., to achieve a certain setpoint humidity for the space.

The heat pump system can improve comfort and sleep quality of occupants by correlating information received from peripheral user controls such as wearable technology, and adjusting, for example, the setpoints for temperature, humidity, air flow, and air flow direction (e.g., louver angles).

The heat pump system can balance the operation of multiple IDUs and ODUs to produce a similar outcome as if each were operated individually, but with lower energy consumption and/or cost.

The heat pump system can switch between heating and cooling modes for the ODU(s) over time, to allow for heating one space and cooling another, without user intervention. The heat pump system can recover some of the thermal energy stored in the system when switching between heating and cooling modes to cool one space and heat another, e.g., the heat stored in an outdoor heat exchanger after cooling one space.

The control system can use current and future (scheduled or predicted) occupancy as an input to the model predictive control algorithm, e.g., allowing for higher fan speeds that cause more noise when a space is unoccupied.

The control system can detect discrepancies between reference and measured data, and detect malfunctions or other undesirable conditions such as open windows or doors (e.g., using data collected from window and/or door sensors), or failing/malfunctioning system components. Such reference data may have been collected by the control system for the specific home, and may be combined with data for several homes via a cloud management system.

The control system can allow users to specify temperature, humidity, and occupancy schedules that offer a large degree of freedom for the control system to exploit, e.g., to maximize energy efficiency. The control system can use predictive models to simulate the required energy use given selected user settings, and estimate the energy consumption impact of changes in user settings. For example, the control system can use patterns detected in presence data collected from presence sensors, e.g., a millimeter-Wave sensor installed in an IDU, to suggest more efficient setpoint schedules, thereby reducing the energy used to condition spaces while unoccupied. As another example, the control system can suggest more efficient allowable ‘away’ temperature ranges, and provide the user the estimated energy consumption reduction, e.g., to motivate the user to make such adjustments.

These and other features relating to the heat pump systems, control and systems for the heat pump systems, and methods of controlling the heat pump systems are described in further detail below.

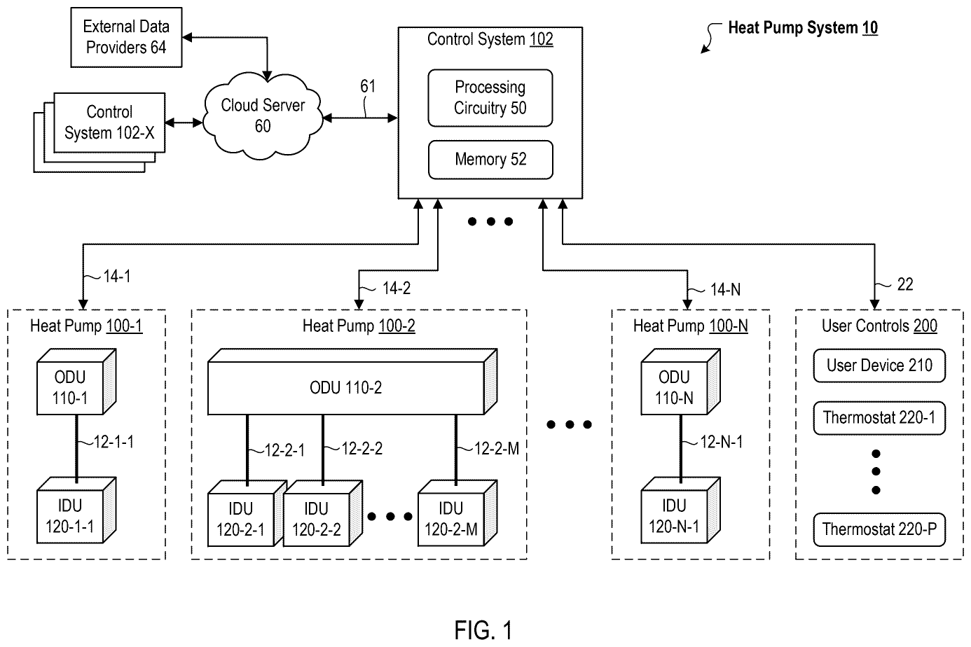

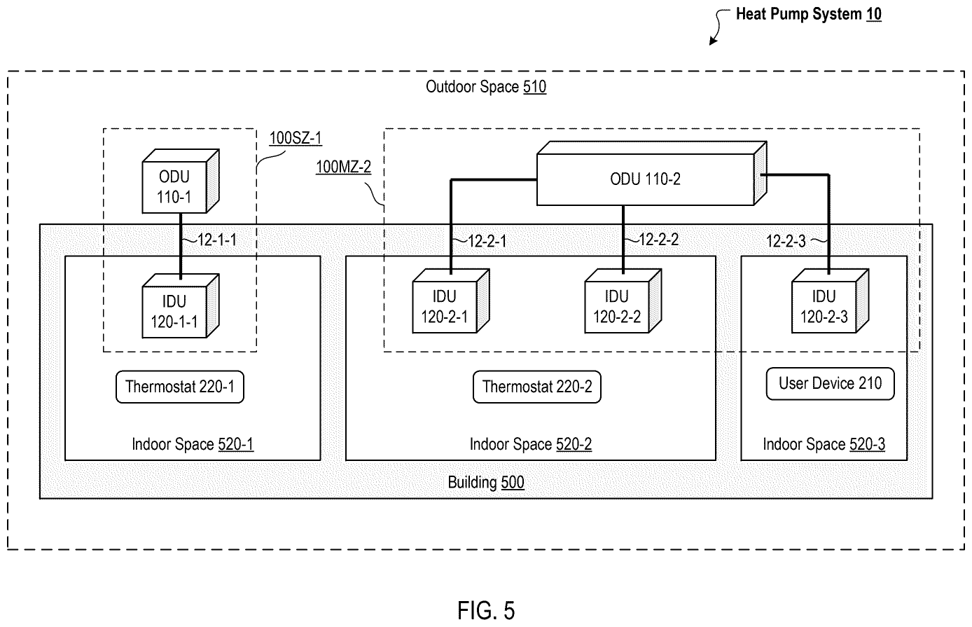

FIG. 1 is a schematic diagram depicting an example of a heat pump system 10. At a high-level, the heat pump system 10 includes a set of one or more heat pumps 100-1 through 100-N and a control system 102 communicatively coupled with the set of heat pumps 100. For reference, FIG. 5 is a schematic diagram depicting an example of a building 500, e.g., a home, office building, or other dwelling, configured with an example configuration of the heat pump system 10 (with the control system 102 omitted for clarity).

As shown in FIG. 1, the control system 102 includes processing circuitry 50 and associated memory 52. The control system 102 is communicatively coupled with each heat pump 100-1 through 100-N via respective bi-directional communication channels 14-1 through 14-N, e.g., wired communication channels (e.g., electrical cable or fiber-optic communication channels) and/or wireless communication channels (e.g., Wi-Fi, Bluetooth, 5G, infrared, or microwave communication channels).

The set of heat pumps 100 is configured to transfer thermal energy between: (i) an outdoor space 510, and (ii) each of one or more indoor spaces 520-1 through 520-D, in accordance with a control sequence u(⋅) computed by the control system 102. That is, the set of heat pumps 100 can heat or cool each indoor space 520 according to the control sequence. For example, the set of heat pumps 100 can perform work in accordance with the control sequence to transfer thermal energy from the (cooler) outdoor space 520 to one or more of the (relatively warmer) indoor space(s) 520 for heating the one or more warmer indoor spaces. Alternatively, or in addition, the set of heat pumps 100 can perform work in accordance with the control sequence to transfer thermal energy from one or more of the (cooler) indoor space(s) 520 to the (relatively warmer) outdoor space 510 for cooling the one or more cooler indoor spaces.

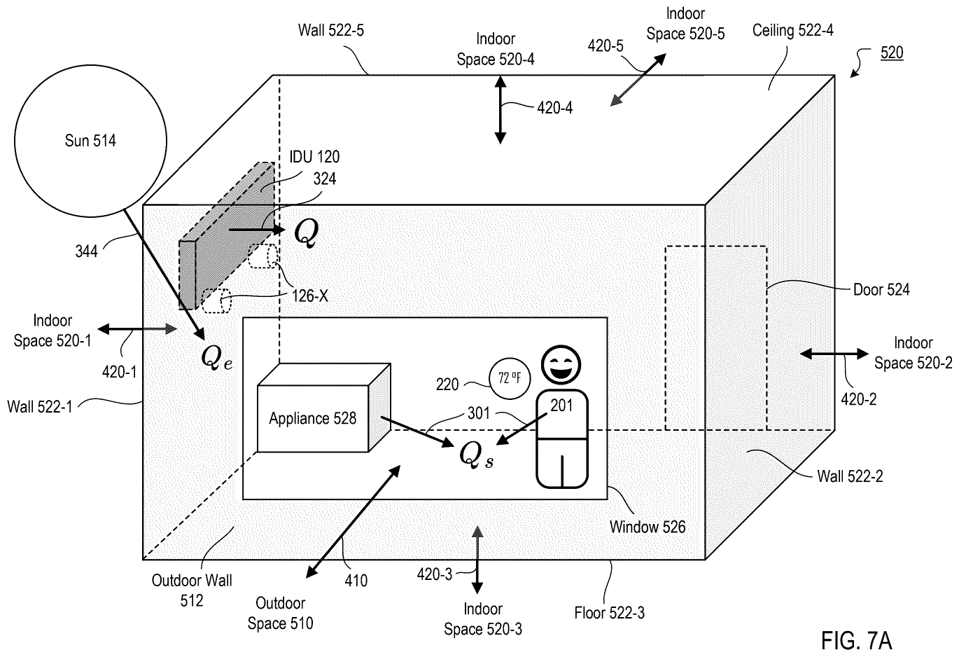

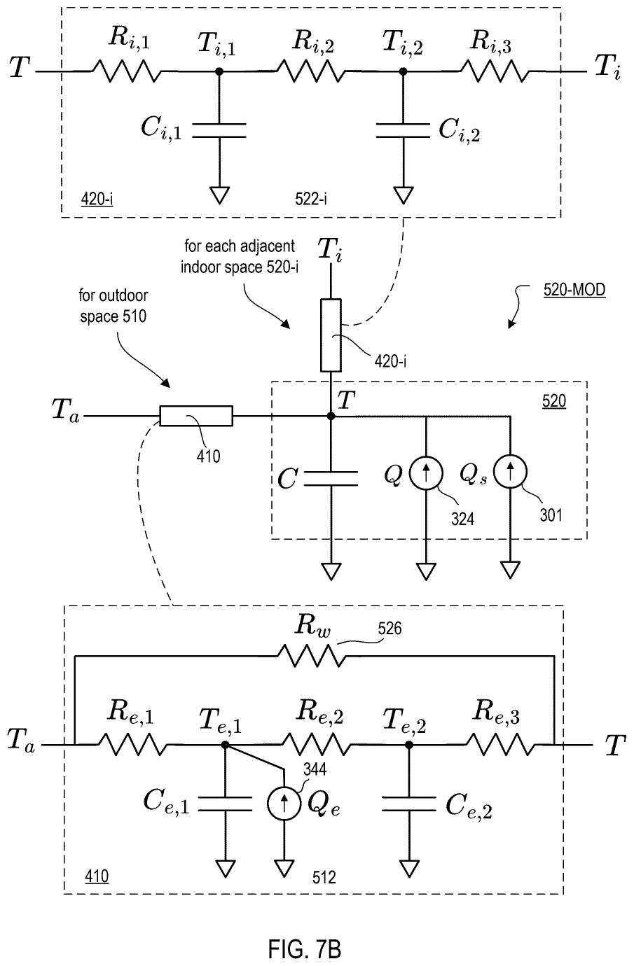

Hence, in some implementations, the set of heat pumps 100 is configured to simultaneously heat or cool each indoor space 520 individually, e.g., operating in a heating mode for a first subset of the indoor space(s) 520, while operating in a cooling mode for a second, different subset of the indoor space(s) 520. For example, the control system 102 can individually control the heating 600A or cooling 600B mode implemented by the respective ODU 110 of each heat pump 100 in the set. For reference, FIG. 7A is a schematic diagram depicting an example of an indoor space 520 thermally coupled to: (i) an outdoor space 510, and (ii) multiple, other indoor spaces 520-1 through 520-5, that are each adjacent to the indoor space 520. FIG. 7B depicts an example thermal model 520-MOD of the indoor space 520.

As used herein, a control sequence u(⋅)={u₀, u₁, u₂, . . . }includes a respective control input (uₙ) for the set of heat pumps 100 at each of multiple time steps tₙ, where n=0, 1, 2, . . . indexes each time step in the control sequence, and n=Nₜₒₜ is the total number of time steps. The control sequence can have a finite or fixed number of time steps, e.g., corresponding to intermittent reboots of the control system 102 or planned maintenance of the heat pump system 10. The control sequence can also run (almost) indefinitely Nₜₒₜ→∞ with little or no interruptions. For example, the control sequence can include 5 or more time steps, 10 or more time steps, 10² or more time steps, 10³ or more time steps, 10⁴ or more time steps, 10⁵ or more time steps, 10⁶ or more time steps, 10⁷ or more time steps, 10⁸ or more time steps, 10⁹ or more time steps, and so on.

A control rate (σ), which can be measured in Hertz (Hz), corresponds to the length of each time step if they are evenly spaced, Δtₙ=tₙ₊₁−tₙ=σ⁻¹. Similarly, the total length of the control sequence is then Nₜₒₜσ⁻¹. For example, the control system 102 can have a control rate of about 5 millihertz (mHz) or more, 10 mHz or more, 15 mHz or more, 20 mHz or more, 25 mHz or more, 50 mHz or more, 75 mHz or more, 100 mHz or more, 200 mHz or more, 300 mHz or more, 400 mHz or more, 500 mHz or more, 1 Hz or more, and so on. In some implementations, the control system 102 can have a relatively fast control rate, e.g., in a range from about 50 mHz to 200 mHz, corresponding an adjustment of the set of heat pumps 100 every twenty seconds to every five seconds. In some implementations, the effective control rate is variable. In other words, the spacing between time steps can periodically increase or decrease, e.g., based on input from a user, during an away period of an occupancy schedule, active refinement of the predictive models during the control sequence, or other considerations.

A control input

$${u}_{n} = {\{ {u}_{n , j} \}}_{j = 1}^{N}$$

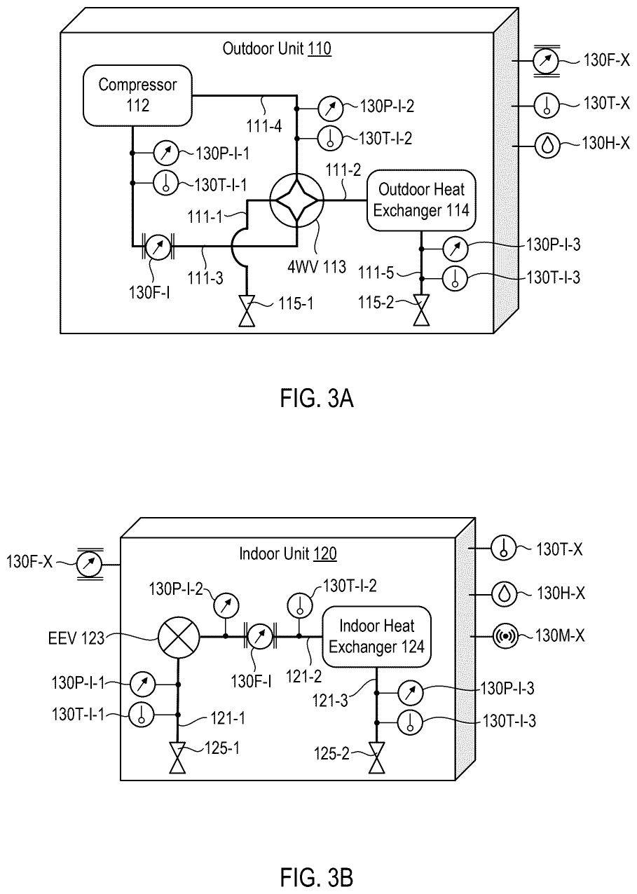

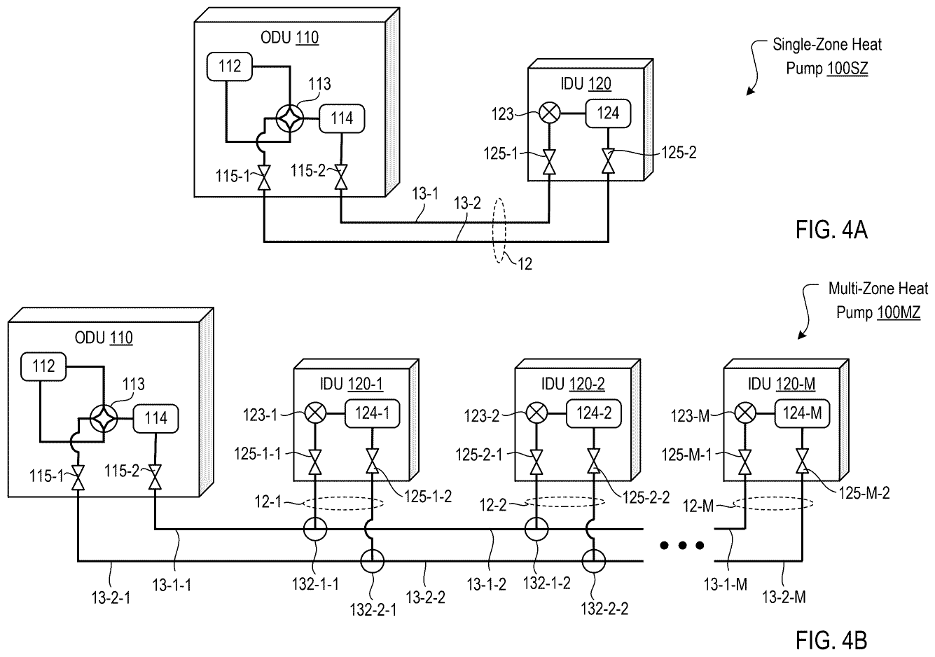

for the set of heat pumps 100 can be further discretized into a respective control input (u_{n,j}) for each heat pump 100 in the set. Here, j indexes a heat pump 100 and N is the total number of heat pumps 100 in the heat pump system 10. In general, a control input for a heat pump 100 includes a respective control value (or control setting) for each of one or more components of the heat pump 100, where the control value(s) manipulate the behavior of the heat pump 100, e.g., the rate at which the heat pump 100 transfers thermal energy between the outdoor space 510 and one or more of the indoor space(s) 520. Examples of different components of a heat pump 100 that can be controlled by a control input are described in more detail with reference to FIGS. 3A-4B.

The control system 102 can execute a model predictive control algorithm to compute an optimal control sequence

$${u}^{*} ( \cdot ) = \{ {u}_{0}^{*} , {u}_{1}^{*} , {u}_{2}^{*} , … \}$$

for the set heat pumps 100. The optimal control sequence includes a respective optimal control input

$$( {u}_{n}^{*} )$$

for the set of heat pumps 100 at each of the time steps. In general, the control system 102 executes the model predictive control algorithm to predict and optimize the future state of the heat pump system 10 based on the current state of the heat pump system 10. In many cases, the control system 102 also executes the model predictive control algorithm based on a scheduled and/or predicted, future state of the heat pump system 10, e.g., a weather forecast of the outdoor space 510, one or more setpoint schedules of the indoor space(s) 520, a reference control sequence for the set of heat pumps 100, a peak pricing schedule for the heat pump system 10, among other factors and/or constraints. For example, the control system 102 can compute an optimal control sequence that minimizes the energy usage or cost of the set of heat pumps 100, e.g., measured in kilowatt-hours (kWh) or United States dollars (USD) over the control sequence, while simultaneously accounting for the thermal couplings between the spaces 510 and 520, e.g., such that the heating or cooling of one indoor space 520 is utilized for (rather than competing with) the heating or cooling of another indoor space 520.

As shown in FIG. 1, a heat pump 100 includes an outdoor unit (ODU) 110 and one or more indoor units (IDUs) 120-1 through 120-M. If the heat pump 100 includes a single IDU 120, it is referred to as a “single-zone heat pump” 100SZ. If the heat pump 100 includes multiple IDUs 120, it is referred to as a “multi-zone heat pump” 100MZ. The ODU 110 is thermally coupled to each of the IDU(s) 120-1 through 120-M via sets of fluid lines 12-1 through 12-M, e.g., refrigerant or gas lines, connected therebetween.

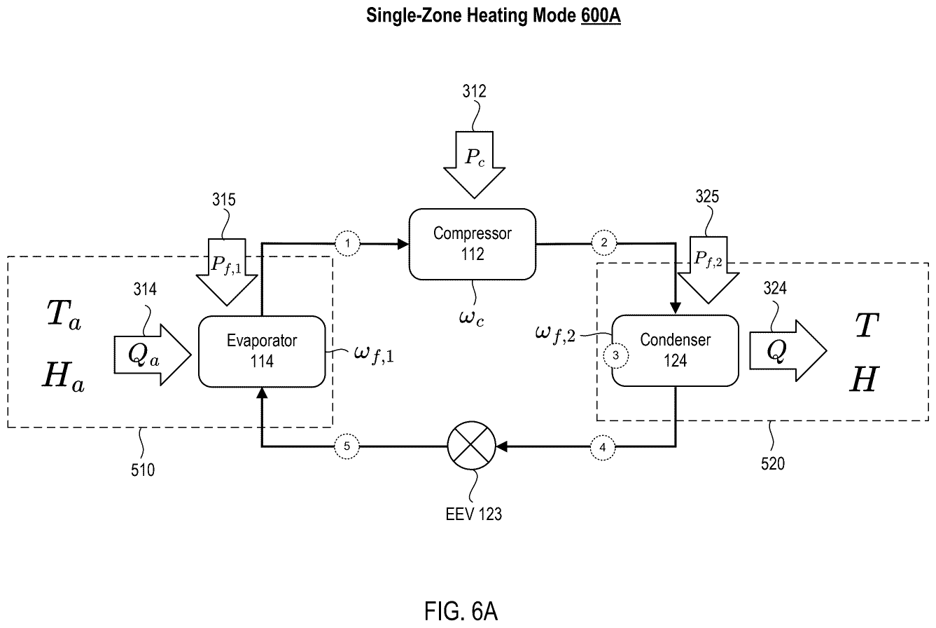

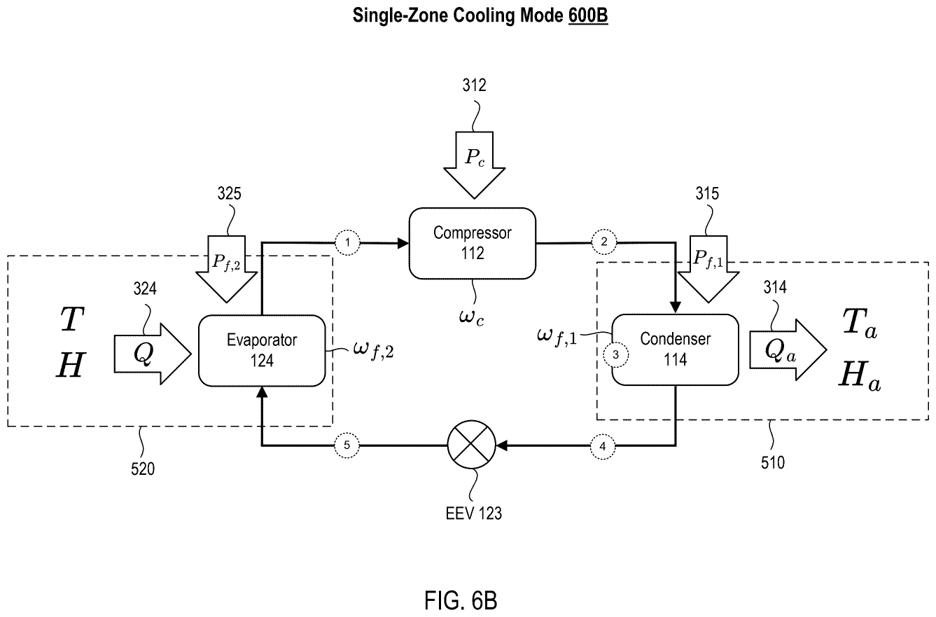

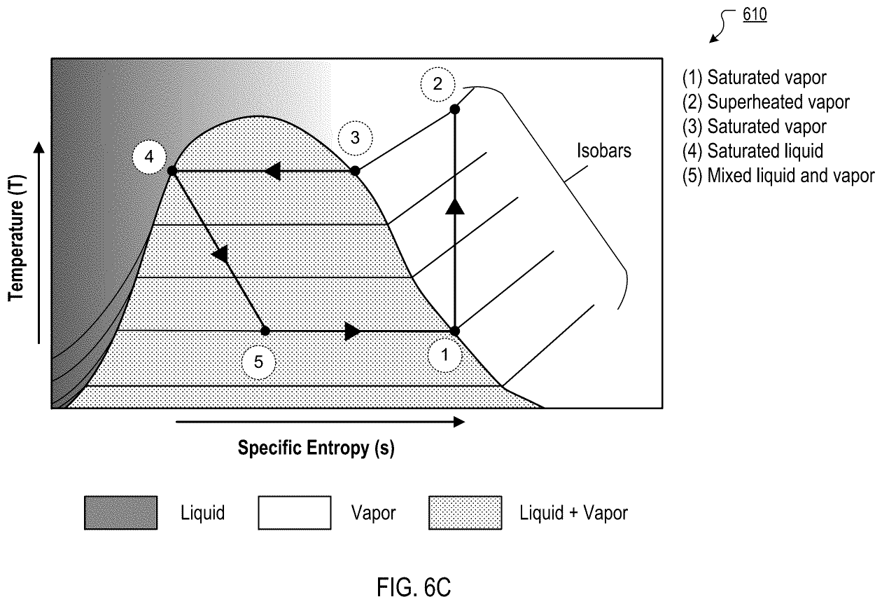

The heat pump 100 is configured to transfer thermal energy from its ODU 110 to each of its IDU(s) 120, or vice versa, by circulating a working fluid in a thermodynamic cycle, e.g., to implement a heating mode 600A or a cooling mode 600B. In some implementations, the working fluid is a refrigerant, and the thermodynamic cycle is a vapor compression cycle. Examples of refrigerants for a vapor-compression cycle include, but are not limited to, R-410A, R-22, R-134a, R-32, and R-1234yf, among others. In some implementations, the working fluid is a gas, and the thermodynamic cycle is a gas cycle. Examples of gases (e.g., refrigerant gases) for a single-phase gas cycle (e.g., a reverse Brayton cycle) include, but are not limited to, air, R-170, R-290, R-600, R-600a, and R-22, among others. For reference, FIGS. 6A and 6B are schematic diagrams depicting an example model of a single-zone heat pump 100SZ in a heating 600A and cooling 600B mode, respectively, when implementing a vapor-compression cycle. FIG. 6C is a phase diagram 610 depicting an example of the vapor-compression cycle.

The ODU 110 of the heat pump 100 can be positioned in the outdoor space 510 and is configured to transfer thermal energy between the working fluid and the outdoor space 510. Each IDU 120 of the heat pump 100 can be positioned in one of the indoor space(s) 520 and is configured to transfer thermal energy between the working fluid and the indoor space 520. The sets of fluid lines 12-1 through 12-M circulate the working fluid between the ODU 110 and each of the IDU(s) 120-1 through 120-M to implement the thermodynamic cycle.

Note, multiple IDUs 120 can be positioned in the same indoor space 520, e.g., in multiple different zones of the indoor space 520, depending on the thermal output of the IDUs 120 and/or the thermal requirements of the indoor space 520. For instance, as shown in the example configuration of the heat pump system 10 in FIG. 5, a first (single-zone) heat pump 100SZ-1 includes an ODU 110-1 positioned in the outdoor space 510 and an IDU 120-1-1 positioned in a first indoor space 520-1. A second (multi-zone) heat pump 100-2 includes an ODU 110-2 positioned in the outdoor space 510, two IDUs 120-2-1 and 120-2-2 positioned in a second indoor space 520-2 adjacent the first indoor space 520-1, and an IDU 120-2-3 positioned in a third indoor space 520-3 adjacent the second indoor space 520-2. The ODUs 110-1 and 110-2 of the heat pumps 100SZ-1 and 100MZ-2 are both positioned in an outdoor space 510 that is adjacent to each of the indoors spaces 520-1, 520-2, and 520-3 and surrounds the indoor spaces 520-1, 520-2, and 520-3. Hence, in general, the indoors spaces 520-1, 520-2, and 520-3 are thermally coupled to one another and each is thermally coupled to the outdoor space 510. The control system 102 can account for such thermally couplings, e.g., via a thermal model of the indoor spaces 520, as well as different configurations and performance metrics of the ODUs 110 and IDUs 120, e.g., via a performance model of the set of heat pumps 100, when computing the optimal control sequence for the set of heat pumps 100.

In light of this, many different configurations of the heat pump system 10 are feasible with IDUs 120 of the heat pumps 100 arranged in different combinations within the indoor space(s) 520. In general, an indoor space 520 can have one or more IDUs 120 of the heat pumps 100 positioned therein, where the one or more IDUs 120 belong to: (i) one or more single-zone heat pumps 100SZ; (ii) one or more multi-zone heat pumps 100MZ; or (iii) one or more single-zone heat pumps 100SZ and one or more multi-zone heat pumps 100MZ.

As one example, an indoor space 520 can have one IDU 120 positioned therein, where the IDU 120 belongs to a single-zone heat pump 100SZ or a multi-zone heat pump 100MZ.

As another example, an indoor space 520 can have two IDUs 120 positioned therein, where one of the two IDUs 120 belongs to a single-zone heat pump 100SZ and the other of the two IDUs 120 belongs to a multi-zone heat pump 100MZ or another, different single-zone heat pump 100SZ. In other cases, one of the two IDUs 120 belongs to a multi-zone heat pump 100MZ and the other of the two IDUs 120 belongs to another, different multi-zone heat pump 100MZ. In yet other cases, both of the two IDUs 120 belong to the same multi-zone heat pump 100MZ. This extends to three or more IDUs 120, four or more IDUs 120, five or more IDUs 120, and so on, positioned in an indoor space 520.

Hence, in implementations involving one single-zone heat pump 100SZ, the heat pump system 10 can be operated as a single-zone heat pump system, e.g., a single-zone variable-speed ductless heat pump system, to efficiently condition a single indoor space 520, e.g., a room, office, studio, or Accessory Dwelling Unit (ADU). Likewise, in implementations involving multiple single-zone heat pumps 100SZ, one or more multi-zone heat pumps 100MZ, or one or more single-zone heat pumps 100SZ and one or more multi-zone heat pumps 100MZ, the heat pump system 10 can be operated as a multi-zone heat pump system, e.g., a multi-zone variable-speed ductless heat pump system, to efficiently condition multiple indoor spaces 520 or multiple zones of one or more indoor spaces 520, e.g., covering part or the whole of a home, residence, or other dwelling. The heat pump system 10 can seamlessly combine more than one IDU 120 per indoor space 520 by balancing the thermal output of each IDU 120, while a user can set the desired temperature, desired humidity, and/or expected occupancy for the indoor space 520.

To facilitate input from one or more users, the heat pump system 10 further includes user controls 200 that are communicatively coupled with the control system 102 via bi-directional communication channels 22, e.g., wired and/or wireless communication channels. The heat pump system 10 can also provide status and health information of the heat pump system 10 to the users via the user controls 200.

As shown in FIG. 1, the user controls 200 include a user device 210, e.g., a mobile user device such as a smart phone, smartwatch (or other wearable user device), tablet, or laptop that allows the heat pump system 10 to be remotely controlled, e.g., via a remote-control application over a wireless communication channel. Note, while one user device 210 is depicted in FIG. 1, the user controls 200 can include multiple such user devices 210 for one or more users of the heat pump system 10. The user controls 200 also include one or more (e.g., smart) thermostats 220-1 through 220-P that each include a (e.g., graphical) user interface for inputting user commands or viewing status and health information of the heat pump system 10.

A user can provide a user input to the control system 102, via the user controls 200, that modifies the optimal control sequence computed by the control system 102. The user controls 200 allow users to provide general or individual preferences for temperature and humidity schedules, setup an occupancy schedule, and/or directly control the set of heat pumps 100. The user controls 200 can also allow users to specify how the heat pump system 10 should tradeoff between comfort, noise, energy usage, energy cost, and/or climate impact (e.g., estimated equivalent carbon dioxide (CO₂) output). Examples of such user inputs are provided below.

As one example, a user input can specify a temperature schedule

$${T}^{′} ( \cdot ) = \{ {T}_{0}^{′} , {T}_{1}^{′} , {T}_{2}^{′} … \}$$

including a respective set of setpoint temperatures

$${T}_{n}^{′} = {\{ {T}_{n , i}^{′} \}}_{i = 1}^{D}$$

for the indoor space(s) 520 for each time step in the control sequence. Here, i indexes an indoor space 520 and D is the total number of indoor spaces 520 conditioned by the heat pump system 10. Note, the temperature of a space generally refers to the degree of hotness or coldness of the space. Temperature can be measured in terms of any appropriate temperature scale such as the Celsius scale (C), the Kelvin scale (K), or the Fahrenheit scale (F).

As another example, a user input can specify a humidity schedule

$${H}^{′} ( \cdot ) = \{ {H}_{0}^{′} , {H}_{1}^{′} , {H}_{2}^{′} … \}$$

including a respective set of setpoint humidities

$${H}_{n}^{′} = {\{ {H}_{n , i}^{′} \}}_{i = 1}^{D}$$

for the indoor space(s) 520 for each time step in the control sequence. Note, the humidity of a space generally refers to the concentration of water vapor present in the air residing in the space. Humidity can be measured in terms of absolute humidity (AH, i.e., the total mass of water vapor present in a volume or mass of air), relative humidity (RH, i.e., the ratio of the partial pressure of water vapor in air to the saturation vapor pressure of water at the same temperature), or specific humidity (SH, i.e., the ratio of the mass of water vapor to the total mass of the air parcel). Specific humidity (or moisture content) is often referred to as the “humidity ratio” and is approximately equal to the mixing ratio, defined as the ratio of the mass of water vapor in an air parcel to the mass of dry air for the same parcel.

As yet another example, a user input can specify an occupancy schedule

$${O}^{′} ( \cdot ) = \{ {O}_{0}^{′} , {O}_{1}^{′} , {O}_{2}^{′} … \}$$

including a respective set of expected occupancies

$${O}^{′} = {\{ {O}_{n , i}^{′} \}}_{i = 1}^{D}$$

for the indoor space(s) 520 for each time step in the control sequence. Note, the occupancy of a space can be measured and modelled in multiple ways depending on the implementation and sophistication of the heat pump system 10.

In some implementations, the occupancy of a space is defined by a probability that the space is occupied by at least one occupant. Here, the occupancy can be a value in a range from 0 to 1, with 0 corresponding to unoccupied (e.g., “false”), 1 corresponding to occupied (e.g., “true”), and values between 0 and 1 providing the likelihood that the space is occupied. In these cases, an expected occupancy at a time step can also be a value in a range from 0 or 1, corresponding to a user's confidence that the space will be occupied at the time step. Alternatively, the expected occupancy can be a binary value of 0 or 1, e.g., where 0 corresponds to an away period and 1 corresponds to presence.

In other implementations, the occupancy of a space is defined by a respective probability that the space is occupied by each of multiple, different occupants. Here, the occupancy can include a respective value in a range from 0 to 1 for each occupant, with 0 corresponding to unoccupied (e.g., “false”), 1 corresponding to occupied (e.g., “true”), and values between 0 and 1 providing the likelihood that the space is occupied by the occupant. In these cases, the expected occupancy of a space at a time step can also include a respective value in a range from 0 to 1 for each occupant, corresponding to a user's confidence that the space will be occupied by the occupant at the time step. Alternatively, the expected occupancy can include a respective binary value of 0 or 1 for each occupant, e.g., where 0 corresponds to an away period for the occupant and 1 corresponds to presence of the occupant. This implementation can be applied in settings when the control system 102 differentiates between individual occupants, e.g., such that the control sequence is modified based on which of the occupants is present or absent.

As a more general version of the above implementation, the occupancy can also be defined by a joint probability distribution over the different occupants. Here, the occupancy can include a respective value in a range from 0 to 1 for each possible permutation of the occupants, e.g., including each occupant, each pair of the occupants, each triplet of the occupants, and so on. This type of occupancy allows for correlations in occupancy, e.g., such that certain groupings of the occupants are more likely to occur, and reduces to the implementation above when no correlations are assumed. That is, the joint probability distribution reduces to a product of the respective probability that the space is occupied by each occupant.

As yet another example, a user input can specify a reference control sequence

$${u}^{′} ( \cdot ) = \{ {u}_{0}^{′} , {u}_{1}^{′} , {u}_{2}^{′} … \}$$

including a respective reference control input (uₙ′) for the set of heat pumps 100 for each time step in the control sequence. These situations can be suitable when a user wishes to directly control one or more of the heat pumps 100 via the user controls 200, e.g., remote-controlling one or more components of one or more of the heat pumps 100 via the user device 210, e.g., a compressor 112, outdoor heat exchanger 114, or indoor heat exchanger(s) 124 of one or more of the heat pumps 100.

The user input may also specify the control rate (σ) of the control system 102, e.g., within some minimum and maximum operational bound, to allow a user to control the rate of adjustment of the set of heat pumps 100. The user input may also include a command to turn on the set heat pumps 100 (e.g., to initiate the control sequence), turn off the set of heat pumps 100 (e.g., to terminate the control sequence), or turn a subset of the heat pumps 100 on or off. For example, to turn off or idle a heat pump 100, a reference control input for the heat pump 100 may be set to a default value

$${u}_{n , j}^{′} = {u}_{off , j}$$

for each time step, e.g., including zero or idling speeds of the compressor 112 and heat exchangers 114 and 124 of the heat pump 100.

In some implementations, a user input can specify one or more constraints on the heat pump system 10, e.g., to indicate to the control system 102 how to tradeoff between comfort, noise, energy usage, energy cost, and/or environmental impact.

For example, to set a “comfort band” for the indoor space(s) 520, a user input can specify a respective minimum (T_{min,i}) and maximum (T_{max,i}) bound on the temperature of each indoor space 520, and/or a respective minimum (H_{min,i}) and maximum (H_{max,i}) bound on the humidity of each indoor space 520. The user input can also specify a respective maximum change in the temperature (ΔTᵢ) and/or humidity (ΔHᵢ) of each indoor space 520 at a time step to control for fluctuations in these parameters.

As another example, to set a “noise band” for the set of heat pumps 100, a user input can specify a respective minimum (u_{min,j}) and maximum (u_{max,j}) bound on the control input for each heat pump 100. The user input can also specify a respective maximum change in the control input (Δuⱼ) of each heat pump 100 at a time step to control for fluctuations in these parameters.

As yet another example, to set an energy usage and/or an energy cost level for the set of heat pumps 100, a user input can specify a respective maximum bound (P_{max,j}) on the net power consumption of each heat pump 100, a maximum bound (Cₘₐₓ) on the total energy cost rate of the set of heat pumps 100, and/or a maximum bound on the total equivalent carbon dioxide (CO₂) output rate of the set of heat pumps 100.

The independent control of each heat pump 100 in the heat pump system 10 allows a user to turn the heat pump system 10 down or off for indoor spaces 520 that are not used for a period of time, either by setting up one or more schedules for each indoor space 520, manually adjusting the heat pump system 10 using a thermostat 220 when entering or leaving the indoor space 520, or remotely via a user device 210, e.g., using a smartphone app. As described in more detail below, the control system 102 can implement some, or all, of these abovementioned schedules and constraints when executing the model predictive control algorithm to compute the optimal control sequence for the set of heat pumps 100. Note, in some implementations, the control system 102 may be initialized with default values for the constraints which can then be modified by a user input, e.g., if the user input does not specify constraints that exceed the hardware limitations of the heat pump system 10.

A thermostat 220 can be positioned in one of the indoor space(s) 520 and includes one or more sensors 130 for collecting status information of the indoor space 520, e.g., measuring a current state (\hat{x}_{n,i}) of the indoor space 520. As used herein, a state x_{n,i}=(T_{n,i},H_{n,i},O_{n,i}) of an indoor space 520 at a time step can include a temperature (T_{n,i}), a humidity (H_{n,i}), and an occupancy (O_{n,i}) of the indoor space 520 at the time step.

Particularly, the thermostat 220 includes a temperature sensor 130T for measuring a current temperature (\hat{T}_{n,i}) of the indoor space 520. For instance, as shown in the example configuration of the heat pump system 10 in FIG. 5, a first thermostat 220-1 is positioned in the first indoor space 520-1 for measuring the current temperature of the first indoor space 520-1, a second thermostat 220-2 is positioned in the second indoor space 520-2 for measuring the current temperature of the second indoor space 520-2, and the user device 210 is positioned in the third indoor space 530-3, e.g., carried by a user occupying the third indoor space 520-3. Examples of temperature sensors 130T include, but are not limited to, thermocouples, thermistors, resistance temperature detectors (RTDs), semiconductor-based integrated circuits, infrared temperature sensors, among others.

The thermostat 220 can also include one or more additional sensors 130 for collecting other status information of the indoor space 520.

For example, the thermostat 220 can include a humidity sensor 130H for measuring a current humidity (Ĥ_{n,i}) of the indoor space 520. Examples of humidity sensors 130H include, but are not limited to, capacitive humidity sensors, resistive humidity sensors, thermal conductivity humidity sensors, among others.

As another example, the thermostat 220 can include a presence sensor 130M for measuring a current occupancy (Ô_{n,i}) of the indoor space 520. For example, the current occupancy can include a binary value of 0 or 1 if the indoor space 520, as currently measured, is occupied or unoccupied. In settings where the control system 102 differentiates between individual occupants, e.g., using gait detection on the presence sensor 130M readings or personalized information from a user device 210, the current occupancy can include a respective binary value of 0 or 1 for each occupant if the indoor space 520, as currently measured, is occupied or unoccupied by the occupant. Examples of presence sensors 130M include, but are not limited to, millimeter-wave (mmWave) sensors, thermal imaging sensors, passive infrared (PIR) sensors, light detection and ranging (LIDAR) sensors, carbon dioxide (CO₂) sensors, window and/or door sensors (e.g., opened/closed or opening angle), connected Internet of things (IoT) sensors, among others.

In some implementations, the user device 210 can also include one or more sensors 130, e.g., heart rate monitors, temperature sensors, accelerometers, a Global Positioning System (GPS), and/or radio detection and ranging (RADAR) sensors, for collecting status information of a user of the user device 210, e.g., biometric data including heart rate, skin temperature, oxygenation, sleep cycle, motion, and/or (geo)location of the user. Such biometric data can be utilized by the control system 102 in conjunction with status information collected by presence sensors 130M to determine the current and/or predicted, future occupancy of each indoor space 520, e.g., based on whether the user is vacant, asleep, or in motion.

In some implementations (e.g., FIGS. 3A-3B), a heat pump 100 can also include one or more sensors 130 for collecting status information of the outdoor space 510, one or more indoor spaces 520, and/or the heat pump 100 itself, e.g., measuring a current state (\hat{x}_{n,a}) of the outdoor space 510, the current states (\hat{x}_{n,i}) of the indoor space(s) 520, and/or a current state (\hat{x}_{n,j}) of the heat pump 100.

As used herein, a state x_{n,a}=(T_{n,a},H_{n,a}) of the outdoor space 510 at a time step can include an ambident temperature (T_{n,a}) and humidity (H_{n,a}) of the outdoor space 510 at the time step. In some implementations, the state of the outdoor space 510 can also include other information about the outdoor space 510, such as an overcast of the outdoor space 510 (e.g., cloud cover of the Sun 514), a wind speed (and direction) relative to a building 500 positioned in the outdoor space 510, and/or coordinates (or an angle) of the Sun 514 relative to the building 500 positioned in the outdoor space 510. For example, the control system 102 can use the (geo)location of the building 500 and the equations from the Astronomical Almanac to calculate the apparent (e.g., ecliptic) coordinates of the Sun 514, as well as the mean equinox and ecliptic of date.

As used herein, a state (x_{n,j}) of a heat pump 100 at a time step can include a respective temperature, pressure, and flow rate of the working fluid at each of one or more thermodynamic points in the thermodynamic cycle implemented by the heat pump 100, at the time step. In some implementations, the state of the heat pump 100 can also include other information about the heat pump 100, such as a charge (or mass) of the working fluid circulating through the heat pump 100, a respective temperature, humidity, and flow rate of input (intake) air and/or output (exhaust) air of each ODU 110 and IDU 120 of the heat pump 100, and/or a power, current, and/or voltage consumed by the heat pump 100.

In some implementations, the heat pump system 10 can also be connected to a cloud management system (or cloud server) 60. Here, the control system 102 can access the cloud server 60 via a secure network connection 61 over the Internet. The cloud server 60 can provide access to current and historical data collected from control systems 102-X of other heat pump systems that are also connected to the cloud server 60, e.g., heat pump systems of other homes, office buildings, or dwellings. The cloud server 60 may also be configured to control some, or all, of the connected heat pump systems. For example, the cloud server 60 may be implemented as a centralized control system that manages multiple heat pump systems owned by an enterprise, e.g., with a respective heat pump system configured for each office building that the enterprise owns. Engineering and laboratory data about the ODUs 110 and IDUs 120 can be made available to the control system 102 via the cloud server 60. Such data can be utilized by the control system 102 for performing temperature feedback control, model predictive control, and/or model estimation and refinement. This data can include component specifications such as compressor performance curves, and tables, charts, or curves that yield energy consumption and thermal output as a function of various parameters for the specific combination of ODUs 110 and IDUs 120 utilized by the heat pump system 10. The cloud server 60 may also provide direct or cloud-to-cloud integration with external data providers 64, e.g., third-party applications and hardware such as smartphones, wearable devices, and IoT devices.

The user controls 200 and/or the cloud server 60 can also provide the control system 102 with access to predictive data characterizing predicted, future constraints placed on the heat pump system 10 from external factors, e.g., weather conditions and/or an energy provider. As one example, the control system 102 can receive, e.g., from a weather app installed on the user controls 200, a (e.g., local) weather forecast

$${x}_{a}^{′} ( \cdot ) = \{ {x}_{0 , a}^{′} , {x}_{1 , a}^{′} , {x}_{2 , a}^{′} … \}$$

including a respective predicted state

$$( {x}_{n , a}^{′} )$$

of the outdoor space 510 for each time step in the control sequence. As another example, the control system 102 can also receive, e.g., from an energy provider via the cloud server 60, a peak pricing schedule ψ(⋅)={ψ₀, ψ₁, ψ₂ . . . }including a respective predicted price of energy (ψₙ) for each time step in the control sequence. The price of energy can be measured in United States Dollars per kilowatt-hour (USD/kWh), or in terms of some other (e.g., local) currency.

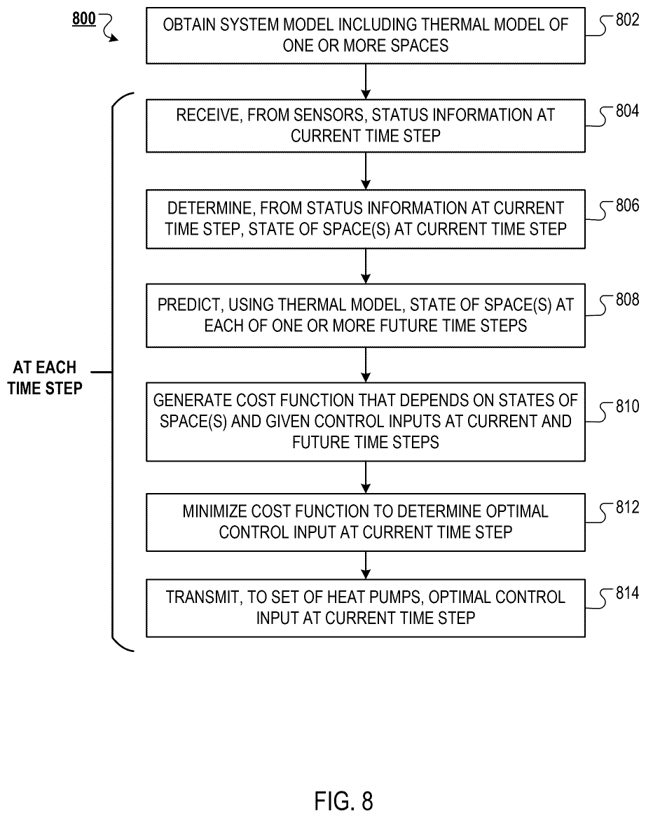

As shown in FIG. 1, the control system 102 includes processing circuitry 50 and associated memory 52 for processing status information collected by the sensors 130 of the heat pump system 10, handling bi-directional communications for the heat pump system 10, and executing the model predictive control algorithm to compute the optimal control sequence for the set of heat pumps 100. Details of the model predictive control algorithm performed by the control system 102 are described with reference to FIG. 8.

Note, various implementations of the control system 102 are feasible depending on the configuration and requirements of the heat pump system 10, e.g., the number of ODUs 110 and/or IDUs 120, the quality of the communication channels 14 and 22, the accessibility of the control system 102 for maintenance, among other factors.

For example, in some implementations, the control system 102 is a single control device 106, e.g., housed in one of the ODUs 110, one of the IDUs 120, or a separate module. These implementations may be preferred when the heat pump system 10 is a single-zone heat pump system, e.g., to reduce complexity and facilitate easier maintenance of the control system 102.

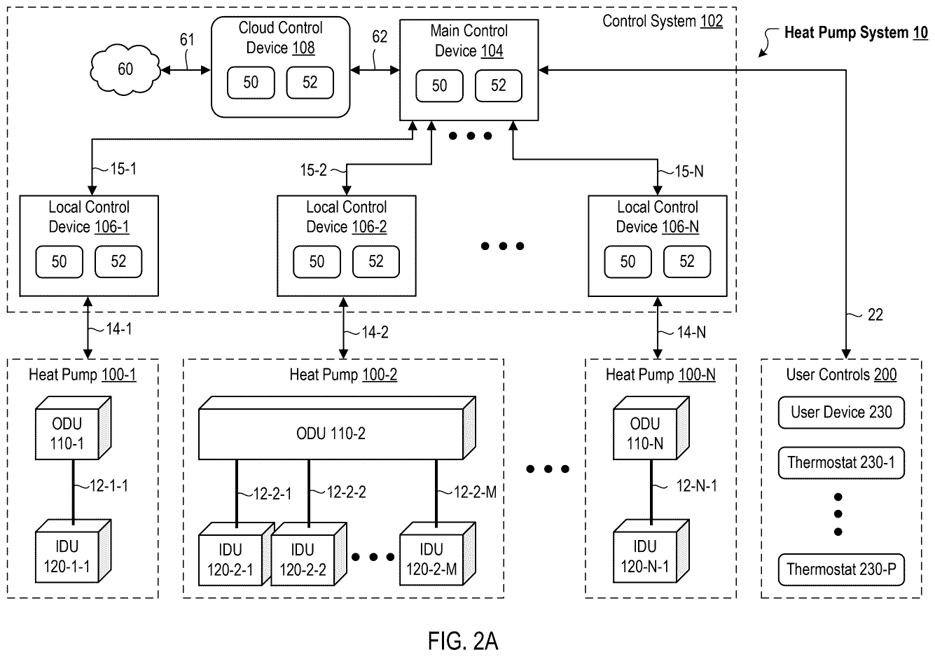

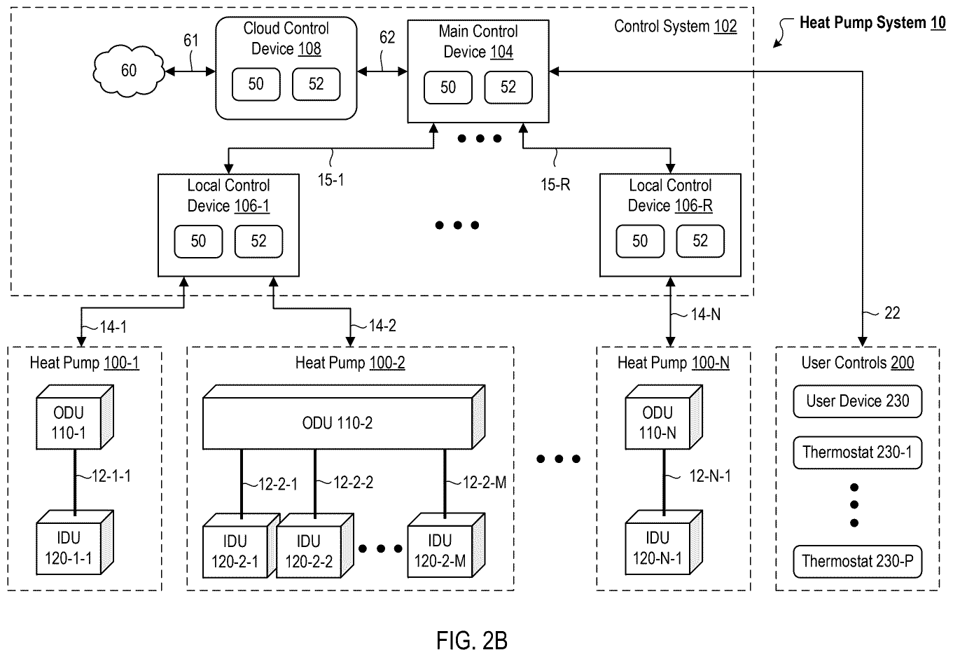

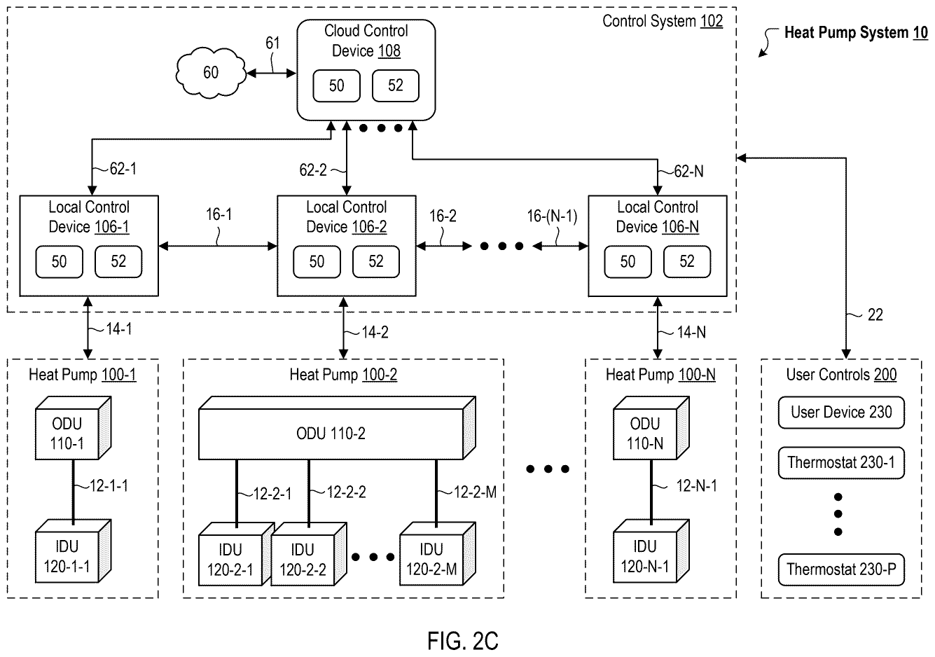

In other implementations, the control system 102 is a distributed control system including multiple control devices 104 and 106, e.g., housed in the ODUs 110, IDUs 120, and/or in one or more separate modules. Here, the control devices 104 and 106 may be identical to one another, e.g., having the same computing architecture. These implementations may be preferred when the heat pump system 10 is a multi-zone heat pump system, e.g., to handle malfunction or shutdown of a part of the heat pump system 10 while still providing control and use of the functional part of the heat pump system 10. Examples of such implementations of the control system 102 are described below with reference to FIGS. 2A-2B.

FIG. 2A is a schematic diagram depicting an example configuration of the heat pump system 10, where the control system 102 is a distributed control system including multiple control devices 104 and 106-1 through 106-N.

Particularly, the control system 102 includes: (i) a main control device 104, and (ii) a respective control device 106 for each heat pump 100 in the heat pump system 10. For example, the main control device 104 may be housed in a separate module and each control device 106 may be a local control device housed in its respective heat pump 100, e.g., the ODU 110 or an IDU 120 of the heat pump 100. Here, the control system 102 further includes a cloud control device 108 communicatively coupled with the main control device 104 via a bi-directional communication channel 62, e.g., a wireless communication channel. The cloud control device 108 connects the heat pump system 10 to the cloud server 60 and facilitates communications therebetween, e.g., allowing the main control device 104 to access and/or be remote-controlled by the cloud server 60.

As shown in FIG. 2A, the control devices 104 and 106 each include processing circuitry 50 and associated memory 52 for performing their assigned function and handling bi-directional communications with their part of the heat pump system 10. For example, each of the control devices 104 and 106 can receive status information from the respective sensors 130 and transmit control information (e.g., control values) to the respective components of the heat pump 100 that the control device 104 or 106 is communicatively coupled with. The control devices 104 and 106-1 through 106-N are also communicatively coupled with one another via respective bi-directional communication channels 15-1 through 15-N, e.g., wireless communication channels.

Hence, the control devices 104 and 106 can also exchange control and status information with one another. In this example, the main control device 104 can be responsible for communications with the user controls 200 and cloud control device 108, as well as executing the model predictive control algorithm to compute the optimal control sequence for the set of heat pumps 100. Control devices 106-1 through 106-N can each be responsible for communications between the main control device 104 and their respective heat pump 100-1 through 100-N, e.g., transmitting respective control and status information between the main control device 104 and their respective heat pump 100.

FIG. 2B is a schematic diagram depicting another example configuration of the heat pump system 10, where the control system 102 is a distributed control system including a main control device 104 and multiple (e.g., local) control devices 106-1 through 106-R.

The control system 102 is configured similarly to the example configuration of the heat pump system 10 shown in FIG. 2A. However, in this implementation, the control system 102 includes a respective control device 106 for each of one or more of the heat pumps 100 in the heat pump system 10, that is, with R<N. For example, as shown in FIG. 2B, control device 106-1 is communicatively coupled with heat pumps 100-1 and 100-2 via communication channels 14-1 and 14-2, e.g., for transmitting control and status information between the main control device 104 and the heat pumps 100-1 and 100-2.

FIG. 2C is a schematic diagram depicting another example configuration of the heat pump system 10, where the control system 102 is a distributed control system including multiple (e.g., local) control devices 106-1 through 106-N.

The control system 102 is configured similarly to the example configuration of the heat pump system 10 shown in FIG. 2A. However, in this implementation, the control system 102 does not include the main control device 104 and the functions performed by the main control device 104 are allocated to the control devices 106-1 through 106-N. Here, each of the control devices 106-1 through 106-N is responsible for communications with the user controls 200 and cloud control device 108, executing the model predictive control algorithm to compute the optimal control sequence for the set of heat pumps 100, and communications between their respective heat pump 100-1 through 100-N, e.g., transmitting and receiving respective control and status information to and from their respective heat pump 100.

FIG. 3A is a schematic diagram depicting an example of an ODU 110. The ODU 110 is configured to transfer thermal energy to or from an outdoor space 510 in accordance with one or more control values, e.g., included in a control input for a heat pump 100 configured with the ODU 110.

The ODU 110 includes a variable-speed (e.g., inverter) compressor 112, a reversing valve 113 (e.g., a four-way valve (4WV)), an outdoor heat exchanger 114, and two valves 115-1 and 115-2 (e.g., tap or gate valves) that are connected to one another via multiple fluid lines 111-1 through 111-5 (e.g., refrigerant or gas lines). The compressor 112, reversing valve 113, outdoor heat exchanger 114, and valves 115-1 and 115-2 can each be communicatively coupled with the control system 102, e.g., via a respective wired or wireless communication channel of communication channels 14, and can each be controlled and/or actuated by the control system 102 via a respective control value.

The fluid lines 111-1 through 111-5 are configured to conduct a working fluid (e.g., a refrigerant or gas) within the ODU 110 when implementing a thermodynamic cycle (e.g., a vapor-compression or gas cycle). Valve 115-1 is connected to fluid line 111-1 to control a flow rate (e.g., a mass and/or volumetric flow rate) of the working fluid flowing in to (or out of) the ODU 110. Likewise, valve 115-2 is connected to fluid line 111-5 to control the flow rate of the working fluid flowing out of (or in to) the ODU 110. The flow rate of the working fluid through the valves 115-1 and 115-2 depends on a size of a respective opening of each valve 115-1 and 115-2, with zero size (closed) corresponding to zero flow rate and maximum size (fully open) corresponding to maximum flow rate.

The compressor 112 is connected between fluid lines 111-3 and 111-4 and is configured to compress, e.g., perform work on, the working fluid flowing between the fluid lines 111-3 and 111-4, thereby increasing the flow rate, temperature, and/or pressure of the working fluid. This is done when the working fluid is in a non-liquid phase, e.g., a vapor or gas phase. The rate of work performed on the working fluid depends on a speed (ω_{c}) of the compressor 112, which can be measured in revolutions per minute (RPM). The direction of the working fluid flowing between fluid lines 111-3 and 111-4 may also depend on whether the speed ω_{c} of the compressor 112 is positive or negative. For ease of description, it is assumed that ω_{c}≥0 is positive and the working fluid flows from fluid line 111-3 to fluid line 111-4 when the compressor 112 is active.

The reversing valve 113 is connected between fluid lines 111-1, 111-2, 111-3, and 111-4 and is configured to reverse a direction of the working fluid circulating in the thermodynamic cycle. Actuation of the reversing valve 113 allows the control system 102 to dynamically switch between heating and cooling modes during execution of a control sequence. The reversing valve 113 generally has two states: (i) an energized state corresponding to a forward (or backward) direction of the working fluid, and (ii) a de-energized state corresponding to a backward (or forward) direction of the working fluid. When one of the two states of the reversing valve 113 is active, e.g., corresponding to a heating mode, the working fluid flows into fluid line 111-5, through the outdoor heat exchanger 114, into fluid line 111-2, through the reversing valve 113, into fluid line 111-3, through the compressor 112, into fluid line 111-4, through the reversing valve 113 once more, and into fluid line 111-1. When the other of the two states of the reversing valve 113 is active, e.g., corresponding to a cooling mode, the working fluid flows into fluid line 111-1, through the reversing valve 113, into fluid line 111-3, through the compressor 112, into fluid line 111-4, through the reversing valve 113 once more, into fluid line 111-2, through the outdoor heat exchanger 114, and into fluid line 111-5.

The outdoor heat exchanger 114 is connected between fluid lines 111-2 and 111-5 and is configured to transfer thermal energy between the working fluid and the outdoor space 510. In general, the outdoor heat exchanger 114 is an outdoor air-to-fluid heat exchanger including: (i) an outdoor coil (e.g., an outdoor radiator coil) that the working fluid flows through, and (ii) a fan to intake ambient air from the outdoor space 510 and increase convective heat transfer. Hence, the net thermal energy transfer rate between the ODU 110 and the outdoor space 510 depends, at least in part, on a speed (ω_{f,1}) of the outdoor heat exchanger 114's fan, which can be measured in RPM. In a heating mode (e.g., FIG. 6A), the outdoor heat exchanger 114 can operate as an evaporator, absorbing thermal energy from the outdoor space 510 and expanding the working fluid flowing in its outdoor coil. In a cooling mode (e.g., FIG. 6B), the outdoor heat exchanger 114 can operate as a condenser, releasing thermal energy into the outdoor space 510 and condensing the working fluid flowing in its outdoor coil.

As shown in FIG. 3A, the ODU 110 is also outfitted with multiple sensors 130 for collecting status information of the outdoor space 510 and/or the ODU 110. The sensors 130 can each be communicatively coupled with the control system 102, e.g., via a respective wired or wireless communication channel of communication channels 14, to transmit the status information to the control system 102.

Particularly, the ODU 110 includes multiple (e.g., external) sensors 130-X for collecting status information of the outdoor space 510, input (intake) air extracted from the outdoor space 510 by the outdoor heat exchanger 114, and/or output (exhaust) air expelled from the outdoor heat exchanger 114 into the outdoor space 510.

The sensors 130-X include one or more flow rate sensors 130F-X for measuring a current input air flow rate and/or a current output air flow rate (e.g., a current mass and/or volumetric flow rate). Examples of flow rate sensors 130F include, but are not limited to, differential pressure flow rate sensors, electromagnetic flow rate sensors, heat transfer flow rate sensors, ultrasonic flow rate sensors, thermal flow rate sensors, condensation flow rate sensors, among others.

The sensors 130-X further include one or more temperature sensors 130T-X for measuring a current ambient temperature (\hat{T}_{n,a}) of the outdoor space 510, a current input air temperature, and/or a current output air temperature. The sensors 130-X further include one or more humidity sensors 130H-X for measuring a current ambient humidity (Ĥ_{n,a}) of the outdoor space 510, a current input air humidity, and/or a current output air humidity. Note, to measure flow rate, temperature, and/or humidity of the input or output air, a flow rate sensor 130-F, temperature sensor 130-T, and/or humidity sensor 130-H can be positioned proximate to the outdoor heat exchanger 114's fan, e.g., positioned on a vent of the ODU 110 that the input air passes into or the output air is expelled from.

The ODU 110 further includes multiple (e.g., internal) sensors 130-I for collecting status information of the working fluid flowing within the ODU 110, e.g., measuring a respective current state of the working fluid (e.g., in a liquid, vapor, gas, or mixed phase) at each of one or more thermodynamic points in the thermodynamic cycle, such as (1) a saturated vapor point, (2) a superheated vapor point, (4) a saturated liquid point, and/or (5) a mixed liquid and vapor point in a vapor-compression cycle.

The sensors 130-I include a flow rate sensor 130F-I positioned on fluid line 111-3 for measuring a current flow rate (e.g., a current mass and/or volumetric flow rate) of the working fluid flowing within the ODU 110.

The sensors 130-I also include three temperature sensors 130T-I-1, 130T-I-2, and 130T-I-3 and three pressure sensors 130P-I-1, 130P-I-2, and 130P-I-3 positioned on fluid lines 111-3, 111-4, and 111-5, respectively, for measuring a respective current temperature and pressure of the working fluid flowing through each of the fluid lines 111-3, 111-4, and 111-5. Examples of pressure sensors 130P include, but are not limited to, potentiometric pressure sensors, inductive pressure sensors, capacitive pressure sensors, piezoelectric pressure sensors, strain gauge pressure sensors, variable reluctance pressure sensors, aneroid barometer pressure sensors, manometer pressure sensors, bourdon tube pressure sensors, vacuum pressure sensors, among others. The sensors 130-I may also measure (at least a portion of) a current charge (or mass) of the working fluid, e.g., based on the current flow rate, temperature, and/or pressure of the working fluid, and the total length of fluid lines in the ODU 110, e.g., according to the ideal gas law.

In some implementations, the sensors 130 may include microphone, accelerometer, and/or other acoustic and vibration sensors for measuring noise and/or vibrations generated by the ODU 110. The sensors 130 may also include current and voltage sensors for measuring the real electrical power consumed by parts or the whole of the ODU 110.

FIG. 3B is a schematic diagram depicting an example of an IDU 120. The IDU 120 is configured to transfer thermal energy to or from an indoor space 520 in accordance with one or more control values, e.g., included in a control input for a heat pump 100 configured with the IDU 120.

The IDU 120 includes an electronic expansion valve (EEV) 123 (e.g., a thermal expansion valve (TXV)), an indoor heat exchanger 124, and two valves 125-1 and 125-2 (e.g., tap or gate valves) that are connected to one another via multiple fluid lines 121-1 through 121-3 (e.g., refrigerant or gas lines). The EEV 123, indoor heat exchanger 124, and valves 125-1 and 125-2 can each be communicatively coupled with the control system 102, e.g., via a wired or wireless communication channel of communication channels 14, and can each be controlled and/or actuated by the control system 102 via a respective control value. Note, while depicted in FIG. 3B as housed in the IDU 120, in some implementations, the EEV 123 can be housed inside an ODU 110 that is thermally coupled to the IDU 120, or positioned outside both the ODU 110 and IDU 120, e.g., in a control or access panel of a building 500.

The fluid lines 121-1 through 121-3 conduct a working fluid (e.g., a refrigerant or gas) within the IDU 120 when implementing a thermodynamic cycle (e.g., a vapor-compression or gas cycle). Valve 125-1 is connected to fluid line 121-1 to control a flow rate (e.g., a mass and/or volumetric flow rate) of the working fluid flowing in to (or out of) the IDU 120. Likewise, valve 125-2 is connected to fluid line 121-3 to control the flow rate of the working fluid flowing out of (or in to) the IDU 120. The flow rate of the working fluid through the valves 125-1 and 125-2 depends on a size of a respective opening of each valve 125-1 and 125-2, with zero size (closed) corresponding to zero flow rate and maximum size (fully open) corresponding to maximum flow rate.

The EEV 123 is connected between fluid lines 111-1 and 111-2 and is configured to expand and/or change a phase of the working fluid circulating in the thermodynamic cycle. In general, the change in flow rate, temperature, and/or pressure of the working fluid through the EEV 123 depends on a size of an opening of the EEV 123. The size of the opening can be determined by the control system 102 based on the demand of a heat pump 100 configured with the IDU 120. For example, the control system 102 can instruct a step motor to open or close the EEV 123 to a certain size to regulate the amount of working fluid released into a heat exchanger 114 or 124 operating as an evaporator, e.g., such that the superheat of the working fluid flowing out of the evaporator is maintained at a steady value, e.g., a value with no portion of the working fluid in a non-liquid phase before entering a compressor 112 of an ODU 110.

The indoor heat exchanger 124 is connected between fluid lines 111-2 and 111-3 and is configured to transfer thermal energy between the working fluid and the indoor space 520. In general, the indoor heat exchanger 124 is an indoor air-to-fluid heat exchanger including: (i) an indoor coil (e.g., an indoor radiator coil) that the working fluid flows through, and (ii) a fan to intake air residing in the indoor space 520 and increase convective heat transfer. Hence, the net thermal energy transfer rate between the IDU 120 and the indoor space 520 depends, at least in part, on a speed (ω_{f,2}) of the indoor heat exchanger 124's fan, which can be measured in RPM. In a heating mode (e.g., FIG. 6A), the indoor heat exchanger 124 can operate as a condenser, releasing thermal energy into the indoor space 520 and condensing the working fluid flowing in its indoor coil. In a cooling mode (e.g., FIG. 6B), the indoor heat exchanger 124 can operate as an evaporator, absorbing thermal energy from the indoor space 520 and expanding the working fluid flowing in its indoor coil.

As shown in FIG. 3B, the IDU 120 is also outfitted with multiple sensors 130 for collecting status information of the indoor space 520 and/or the IDU 120. The sensors 130 can each be communicatively coupled with the control system 102, e.g., via a respective wired or wireless communication channel of communication channels 14, to transmit the status information to the control system 102.

Particularly, the IDU 120 includes multiple (e.g., external) sensors 130-X for collecting status information of the indoor space 520, input (intake) air extracted from the indoor space 520 by the indoor heat exchanger 124, and/or output (exhaust) air expelled from the indoor heat exchanger 124 into the indoor space 520.

The sensors 130-X include one or more flow rate sensors 130F-X for measuring a current input air flow rate and/or a current output air flow rate (e.g., a current mass and/or volumetric flow rate). The sensors 130-X further include one or more temperature sensors 130T-X for measuring a current temperature (\hat{T}_{n,i}) of the indoor space 520, a current input air temperature, and/or a current output air temperature. The sensors 130-X further include one or more humidity sensors 130H-X for measuring a current humidity (Ĥ_{n,i}) of the indoor space 520, a current input air humidity, and/or a current output air humidity. Note, to measure flow rate, temperature, and/or humidity of the input or output air, a flow rate sensor 130-F, temperature sensor 130-T, and/or humidity sensor 130-H can be positioned proximate to the indoor heat exchanger 124's fan, e.g., positioned on a vent of the IDU 120 that the input air passes into or the output air is expelled from. Here, the sensors 130-X also include one or more presence sensors 130M-X for measuring a current occupancy (Ô_{n,i}) of the indoor space 520.

The IDU 120 further includes multiple (e.g., internal) sensors 130-I for collecting status information of the working fluid flowing within the IDU 120, e.g., measuring a respective state of the working fluid (e.g., in a liquid, vapor, gas, or mixed phase) at each of one or more different thermodynamic points in the thermodynamic cycle, such as (1) a saturated vapor point, (2) a superheated vapor point, (4) a saturated liquid point, and/or (5) a mixed liquid and vapor point in a vapor-compression cycle.

The sensors 130-I include a flow rate sensor 130F-I positioned on fluid line 121-2 for measuring a current flow rate (e.g., a current mass and/or volumetric flow rate) of the working fluid flowing within the IDU 120. The sensors 130-I also include three temperature sensors 130T-I-1, 130T-I-2, and 130T-I-3 and three pressure sensors 130P-I-1, 130P-I-2, and 130P-I-3 positioned on fluid lines 121-1, 121-2, and 121-3, respectively, for measuring a respective current temperature and pressure of the working fluid flowing through each of the fluid lines 121-1, 121-2, and 121-3. The sensors 130-I may also measure (at least a portion of) a current charge (or mass) of the working fluid, e.g., based on the current flow rate, temperature, and/or pressure of the working fluid, and the total length of fluid lines within the IDU 120, e.g., according to the ideal gas law.

In some implementations, the sensors 130 may include microphone, accelerometer, and/or other acoustic and vibration sensors for measuring noise and/or vibrations generated by the IDU 120. The sensors 130 may also include current and voltage sensors for measuring the real electrical power consumed by parts or the whole of the IDU 120.

FIG. 4A is a schematic diagram depicting an example of a single-zone heat pump 100SZ. The single-zone heat pump 100SZ includes an ODU 110 and an IDU 120 configured similarly to FIGS. 3A and 3B, respectively.

The ODU 110 and IDU 120 are thermally coupled to each other via a set of fluid lines 12. The fluid lines 12 includes a first (e.g., input or output) fluid line 13-1 connected between valves 115-2 and 125-1, and a second (e.g., output or input) fluid line 13-2 connected between valves 115-1 and 125-2. The fluid lines 12 circulate a working fluid between the ODU 110 and IDU 120 in a forward or backward direction depending on the energized or de-energized state of the reversing valve 113, corresponding to a heating mode (e.g., FIG. 6A) or a cooling mode (e.g., FIG. 6B). Note, while depicted in FIG. 4A as housed in the IDU 120, in some implementations, the EEV 123 can be housed inside the ODU 110, or positioned outside both the ODU 110 and IDU 120, e.g., in a control panel, a valve manifold panel, or other access panel. Similarly, one or more of the valves 115-1, 115-2, 125-1, and 125-2 may also be housed in the control panel, valve manifold panel, or other access panel.

Here, a control input (uⱼ) for the single-zone heat pump 100SZ can include a respective control value for each of: (i) the speed of the compressor 112, (ii) the energized or de-energized state of the reversing valve 113, (iii) the speed of the outdoor heat exchanger 114's fan, (iv) the speed of the indoor heat exchanger 124's fan, (v) the size of the opening of the EEV 123, and (vi) the respective size of the opening of each of the valves 115-1, 115-2, 125-1, and 125-2.

FIGS. 6A-6C show an example model of the single-zone heat pump 100SZ. FIG. 6A is a schematic diagram depicting an example model of the single-zone heat pump 100SZ when implementing a vapor-compression cycle in a heating mode 600A, that is, to heat an indoor space 520. FIG. 6B is a schematic diagram depicting an example model of the single-zone heat pump 100SZ when implementing the vapor-compression cycle in a cooling mode 600B, that is, to cool the indoor space 520. FIG. 6C is a phase diagram 610 depicting an example model of the vapor-compression cycle that can be implemented by the single-zone heat pump 100SZ. The phase diagram 610 shows different phases of a refrigerant circulating in the vapor-compression cycle as a function of specific entropy and temperature of the refrigerant. The phases of the refrigerant include: (1) a saturated vapor phase, (2) a superheated vapor phase, (3) a saturated vapor phase, (4) a saturated liquid phase, and (5) a mixed liquid and vapor phase. Isobars in the phase diagram 610 refer to contours of constant pressure of the refrigerant.

As shown in FIG. 6A, when operating in the heating mode 600A, (1) to (2) corresponds to compression of the refrigerant via the compressor 112 by performing work (P_{c}) 312 on the refrigerant, e.g., in accordance with the speed (ω_{c}) of the compressor 112. The compressor 112 increases the temperature and pressure of the refrigerant, causing the refrigerant to undergo a phase change from the saturated vapor phase to the superheated vapor phase.

(2) to (3) and (3) to (4) correspond to transfer of super and latent heat (Q) 324 in the refrigerant to the indoor space 520 via the indoor heat exchanger 124 (operating as the condenser), which is aided by power (P_{f,2}) 325 consumed by the indoor heat exchanger 124's fan, e.g., in accordance with the speed (ω_{f,2}) of the fan. The refrigerant condenses from the superheated vapor phase to the saturated liquid phase along an isobar of constant pressure. In general, the amount of heat 324 transferred from the refrigerant to the indoor space 520 also depends on the temperature and humidity of the indoor space 520, e.g., due to a temperature gradient between the indoor heat exchanger 124 and the indoor space 520 and the moisture content of the indoor space 520 affecting the convective heat gain from the indoor heat exchanger 124.

(4) to (5) corresponds to expansion of the refrigerant via EEV 123. The EEV 123 decreases the temperature and pressure of the refrigerant, causing the refrigerant to undergo a phase change from the saturated liquid phase to the mixed liquid and vapor phase.

(5) to (1) corresponds to transfer of heat (Qₐ) 314 from an outdoor space 510 to the refrigerant via the outdoor heat exchanger 114 (operating as the evaporator), aided by power (P_{f,1}) 325 consumed by the outdoor heat exchanger 114's fan, e.g., in accordance with the speed (ω_{f,1}) of the fan. The refrigerant evaporates from the mixed liquid and vapor phase to the saturated vapor phase along an isobar of constant pressure, completing the thermodynamic loop in the vapor-compression cycle. In general, the amount of heat 314 transferred from the outdoor space 510 to the refrigerant also depends on the ambient temperature and humidity of the outdoor space 510, e.g., due to a temperature gradient between the outdoor heat exchanger 114 and the outdoor space 510 and the moisture content of the outdoor space 510 affecting the convective heat gain from the outdoor space 510.

The vapor-compression cycle for cooling mode 600B is similar for heating mode 600A, but with the heat exchangers 114 and 124 swapping roles. As shown in FIG. 6B, when operating in the cooling mode 600B, (1) to (2) corresponds to compression of the refrigerant via the compressor 112 by performing work 312 on the refrigerant, e.g., in accordance with the speed of the compressor 112.

(2) to (3) and (3) to (4) correspond to transfer of super and latent heat 314 in the refrigerant to the outdoor space 510 via the outdoor heat exchanger 114 (operating as the condenser), aided by power 315 consumed by the outdoor heat exchanger 114's fan, e.g., in accordance with the speed of the fan.

(4) to (5) corresponds to expansion of the refrigerant via the EEV 123.

(5) to (1) corresponds to transfer of heat 324 from the indoor space 520 to the refrigerant via the indoor heat exchanger 124 (operating as the evaporator), aided by power 325 consumed by the indoor heat exchanger 124's fan, e.g., in accordance with the speed of the fan.

FIG. 4B is a schematic diagram depicting an example of a multi-zone heat pump 100MZ. The multi-zone heat pump 100MZ includes an ODU 110 and multiple IDUs 120-1 through 120-M, where the ODU 110 and each IDU 120-1 through 120-M is configured similarly to FIGS. 3A and 3B, respectively.

The ODU 110 is thermally coupled to each IDU 120-1 through 120-(M-1) via a respective first three-way valve (3WV) 132-1 positioned on a first (e.g., input or output) fluid channel 13-1, and a respective second 3WV 132-2 positioned on a second (e.g., output or input) fluid channel 13-2. Here, fluid channel 13-1 includes multiple fluid lines 13-1-1 through 13-1-M interconnecting 3WVs 132-1-1 through 132-1-M. Similarly, fluid channel 13-2 includes multiple fluid lines 13-2-1 through 13-2-(M-1) interconnecting 3WVs 132-2-1 through 132-2-(M-1).

In general, a 3WV 132 can be configured into one of multiple types of diverting patterns. Such diverting patterns include: (i) a three-way pattern (e.g., a T-pattern) that allows flow of a working fluid in to and out of each of the 3WV 132's three ports, and (ii) multiple two-way patterns (e.g., L-patterns and straight-line patterns) that allow flow of the working fluid in to and out of two of the 3WV 132's three ports. The 3WVs 132 can each be communicatively coupled with the control system 102, e.g., via a respective wired or wireless communication channel of communication channels 14, and can each be controlled and/or actuated by the control system 102 via a respective control value.

The ODU 110 has fluid lines 13-1-1 and 13-2-1 connected to its valves 115-1 and 115-2. Each IDU 120-1 through IDU 120-(M-1) has a respective set of fluid lines 12 connected between its 3WVs 131-1 and 131-2 and its valves 125-1 and 125-2. IDU 120-M has fluid lines 13-1-M and 13-2-M directly connected to its valves 125-M-1 and 125-M-2. The fluid channels 13-1 and 13-2 circulate a working fluid between the ODU 110 and each IDU 120-1 and 120-M in a forward direction or a backward direction depending on the energized or de-energized state of the reversing valve 113, corresponding to a heating or cooling mode.

The heating and cooling modes for the multi-zone heat pump 100MZ are similar to that of the single-zone heat pump 100SZ except the working fluid is diverted to and from multiple IDUs 120. Particularly, the multi-zone heat pump 100MZ corresponds to multiple IDUs 120 placed in parallel with one another and, therefore, the ODU 110 effectively sees a single, equivalent IDU 120.

Note, while depicted in FIG. 4B as being housed in the IDUs 120-1 through 120-M, in some implementations, one or more of the EEVs 123-1 through 123-M can be housed inside the ODU 110, or positioned outside the ODU 110 and the IDUs 120-1 through 120-M, e.g., in a control panel, a valve manifold panel, or other access panel. Similarly, one or more of the 3WVs 132-1 through 132-(M-1) and/or one or more of the valves 115-1, 115-2, and 125-1 through 125-M may also be housed in the control panel, valve manifold panel, or other access panel.

Here, a control input (uⱼ) for the multi-zone heat pump 100MZ can include a respective control value for each of: (i) the speed of the compressor 112, (ii) the energized or de-energized state of the reversing valve 113, (iii) the speed of the outdoor heat exchanger 114's fan, (iv) the respective speed of each of the indoor heat exchangers' 124-1 through 124-M fans, (v) the respective size of the opening of each of the EEVs 123-1 through 123-M, (vi) the respective diverting pattern for each of the 3WVs 132-1 through 132-(M-1), and (vii) the respective size of the opening of each of the valves 115-1, 115-2, and 125-1 through 125-M.

FIG. 7A is a schematic diagram depicting an example of an indoor space 520 configured with an IDU 120 of a heat pump 100. For example, the indoor space 520 can be a studio apartment in an apartment building.

The IDU 120 is a thermal source (or sink) providing a net thermal energy transfer rate (Q) between the IDU 120 and the indoor space 520. When considering FIGS. 6A-6B, the net thermal energy transfer rate depends, at least in part, on a control input for the heat pump 100, a temperature and humidity of the indoor space 520, and an ambient temperature and humidity of an outdoor space 510 that an ODU 110 of the heat pump 100 is positioned in.

The indoor space 520 is thermally coupled 410 to the outdoor space 510 via an outer wall 512 that includes a window 526. The thermal coupling 410 between the indoor space 520 and the outdoor space 510 can depend on the occupancy of the indoor space 520, e.g., due to an occupant 201 opening or closing the window 526.

The indoor space 520 is also thermally coupled 420 to each of multiple, other indoor spaces 520-1 through 520-5 via a respective inner wall 522 (or floor or ceiling). Wall 522-5 also includes a door 524. Hence, thermal coupling 520-5 can also depend on the occupancy of the indoor space 520, e.g., due to an occupant 201 opening or closing the door 524.

The indoor space 520 further includes a thermostat 220, an appliance 528 (e.g., a washer and/or dryer), and an occupant 201 of the indoor space 520 positioned therein. The appliance 528 and occupant 201 are another thermal energy source providing a net thermal energy transfer rate (Qₛ) 301 from the appliance 528 and occupant 201 to the indoor space 520. This can also depend on the occupancy of the indoor space 520, e.g., due to the occupant 201 turning the appliance 528 on or off and radiative heat from the occupant 201.

The Sun 514 is yet another thermal energy source providing a net solar thermal energy transfer rate (Qₑ) 344 from the outdoor space 510 to the indoor space 520. Here, the net solar thermal energy transfer rate can depend on the overcast of the outdoor space 510 and/or the coordinate of the Sun 514.

FIG. 7B depicts an example thermal model 520-MOD of the indoor space 520 in FIG. 7A. As shown in FIG. 7B, the thermal model 520-MOD includes a thermal capacitance (C) and the temperature (T) of the indoor space 520, the ambient temperature (Tₐ) of the outdoor space 510, the respective temperature (Tᵢ) of each adjacent indoor space 520-1 through 520-5, the thermal couplings 410 and 420 between each of the spaces 510 and 520, and each of the net thermal energy transfer rates 301, 324, and 344. In some implementations, the thermal model 520-MOD can also include a mass (M) of air residing in the indoor space 520, a humidity (H) of the indoor space 520, an ambident humidity (Hₐ) of the outdoor space 510, and a respective humidity (Hᵢ) of each adjacent indoor space 520-1 through 520-5. In further implementations, the thermal model 520-MOD can also include an occupancy (0) of the indoor space 520 and various parameters (e.g., learned parameters) that characterize how the state of the indoor space 520 affects the time evolution of the occupancy.

The thermal coupling 410 between the indoor space 520 and the outdoor space 510 can be modelled by two thermal capacitances C_{e,1} and C_{e,2} and temperatures T_{e,1} and T_{e,2} for the surfaces of the outer wall 512, three thermal resistances R_{e,1}, R_{e,2}, and R_{e,3}, and a thermal resistance R_{w} for the window 526. However, in a simplified version of the thermal model 520-MOD, e.g., when the temperatures of the outer wall 512 are not modelled, the thermal coupling 410 can be represented as a thermal resistance Rₑ between the indoor space 520 and the outdoor space 510 in parallel with the thermal resistance of the window 526. In some implementations, the thermal coupling 410 can include a mass flow rate (mₐ) of air between the indoor space 520 and the outdoor space 510 that, for example, is a function of an opening of the window 526 between the spaces 520 and 510.

The thermal coupling 420 between the indoor space 520 and an adjacent indoor space 520-i can be modelled by two thermal capacitances C_{i,1} and C_{i,2} and temperatures T_{i,1} and T_{i,2} for the surfaces of the inner wall 522-i, and three thermal resistances R_{i,1}, R_{i,2}, and R_{i,3}. However, in the simplified version of the thermal model 520-MOD, e.g., when the temperatures of the inner wall 522-i are not modelled, the thermal coupling 420 can be represented as a thermal resistance Rᵢ between the indoor space 520 and the adjacent indoor space 520-i.

In some implementations, the thermal coupling 410-i between the indoor space 520 and one or more of the adjacent indoor spaces 520-1 through 520-5 can include a mass flow rate (mᵢ) of air between the indoor space 520 and the adjacent indoor space 520-i. For example, adjacent indoor space 520-5 may transfer air to or from the indoor space 520 due to the door 524 arranged therebetween, e.g., where the mass flow rate is a function of an opening of the door 524.

Thus, in a simplified version of the thermal model 520-MOD, the rate of change of the temperature (T) of the indoor space 520 may be represented, at least approximately, as:

$$C \dot{T} = Q + {Q}_{e} + {Q}_{s} + ( \frac{1}{{R}_{e}} + \frac{1}{{R}_{W}} ) ( {T}_{a} - T ) + {\sum }_{i = 1}^{5} \frac{{T}_{i} - T}{{R}_{i}} , \qquad ( 1 a )$$

where the overdot indicates the derivative with respect to time. The net thermal energy transfer rate (Q) between the IDU 120 and the indoor space 520 may be represented, at least approximately, as:

Q=mₑₓ[Cₚ(Tₑₓ−T)+C_{pw}(HₑₓTₑₓ−HT)]. (1b)

Cₚ is the specific heat of air, C_{pw} is the specific heat of water vapor at zero degrees Celsius. mₑₓ, Tₑₓ, and Hₑₓ are the exhaust air mass flow rate, temperature, and humidity ratio of air expelled from the IDU 120, respectively. H is the humidity ratio of the indoor space 520. The rate of change of the humidity (H) of the indoor space 520 can then be represented, at least approximately, as:

ρV\dot{H}=mₑₓ(Hₑₓ−H)+mₐ(Hₐ−H)+m₅(H₅−H), (1c)

where ρ and V are, respectively, the density and volume of air residing in the indoor space 520. Together, ρV=M, such that the density and volume provide the mass of the air residing in the indoor space 520. To linear order, the rate of change of the occupancy (O) of the indoor space 520 may be represented, at least approximately, as:

\dot{O}=αᵣT+α_{H}H+αₒO+αᵤu, (1d)

where α_{T}, α_{H}, and α_{O} are coefficients for the temperature, humidity, and occupancy of the indoor space 520, respectively, and αᵤ is a coefficient (or matrix) for the control input for the heat pump 100.

Furthermore, the coupled differential equations in Eqs. (1a)-(1d) can be discretized, e.g., using a finite difference method \dot{x}≈[x(t+Δt)−x(t)]/Δt, to approximate the time derivatives and obtain an equation (or mapping) of the form xₙ₊₁=f(xₙ,uₙ;θₙ), where f represents the thermal model 520-MOD of the indoor space 520, xₙ is the state of the indoor space 520 at a time step (n), uₙ is a control input for the heat pump 100 at the time step, and θₙ are the parameters of the thermal model 520-MOD at the time step.

Note, the thermal model 520-MOD of the indoor space 520 is merely one (simplified) example of a thermal model. As described in more detail with reference to FIG. 8, the control system 102 can use thermal models of varying complexities, e.g., both linear and nonlinear, to model the thermal response and occupational behavior of one or more indoor spaces 520.

FIG. 8 is a flow diagram of an example process 800A for controlling the heat pump system 10 with the control system 102. In general, the control system 102 is configured to execute the model predictive control algorithm to compute the optimal control sequence u*(⋅) for the set of heat pumps 100, where the optimal control sequence includes a respective optimal control input

$$( {u}_{n}^{*} )$$

at each time step.

In more detail, the control system 102 first obtains (e.g., provides, retrieves, loads, or otherwise accesses) a system model including a thermal model (f) of the indoor space(s) 520 (802). For example, in some implementations, the system model can be loaded on the control system 102's memory 52. The control system 102 can then access the system model in memory 52 when executing the model predictive control algorithm. In other implementations, the system model may be loaded on or provided by the cloud server 60. In these cases, the control system 102 can access the system model via the cloud server 60 when executing the model predictive control algorithm. In yet other implementations, a first portion of the system model may be loaded in memory 52 and a second portion of the system model may be loaded on or provided by the cloud server 60. For example, the thermal model may be loaded in memory 52 and a performance model of the set of heat pumps 100 may be loaded on or provided by the cloud server 60. In these cases, the control system 102 can then access the first portion of the system model in memory 52 and the second portion of the system model via the cloud server 60 when executing the model predictive control algorithm.

From the thermal model of the indoor space(s) 520, the control system 102 can determine one or more of: (i) the amount of thermal energy in to or out of each of the indoor space(s) 520 that is involved to maintain a setpoint or follow a desired schedule for the indoor space(s) 520; (ii) how outdoor weather conditions (past, present, and forecasted) affect indoor conditions over time; (iii) how outdoor temperature and humidity affect indoor temperature and humidity; (iv) how wind speed and direction affect the temperature of the indoor space(s) 520; (v) how solar loading and daytime and nighttime cloud cover affect the temperature of the indoor space(s) 520; and (vi) how temperatures of the spaces 510 and 520 are thermally coupled to one another.

Before executing the model predictive control algorithm, the control system 102 may have obtained, constructed, and/or modified the thermal model of the indoor space(s) 520 based on, for example, thermal property data of a building 500 including the indoor space(s) 520, an assumed thermal model of the building 500, and/or logged status information of the spaces 510 and 520 of the building 500. In general, the thermal model can be represented mathematically as:

xₙ₊₁=f(xₙ,uₙ;Oₙ). (2a)

The thermal model characterizes a state (xₙ₊₁) of the indoor space(s) 520 at a sequential time step in response to: (i) a state (xₙ) of the indoor space(s) 520 at a given time step, and (ii) a given control input (uₙ) for the set of heat pumps 100 at the given time step. Note, a state

$${x}_{n} = {\{ {x}_{n , i} \}}_{i = 1}^{D}$$

of the indoor space(s) 520 at a given time step can be further discretized into a respective state (x_{n,i}) of each indoor space 520 at the given time step. To reiterate, a state xₙ, =(T_{n,i},H_{n,i},O_{n,i}) of an indoor space 520 at a given time step can include a temperature (T_{n,i}), humidity (H_{n,i}), and occupancy (O_{n,i}) of the indoor space 520 at the given time step. As shown in Eq. (2a), the thermal model is parameterized by a set of model parameters (θₙ) that are allowed to vary at each time step, e.g., according to the state (x_{n,a}) of the outdoor space 510 at the time step θₙ=θ(x_{n,a}), which accounts for multiplicative and/or additive disturbances to xₙ and uₙ.

Note, when modeling the occupancies of the indoor space(s) 520, the thermal model generally includes a behavioral (or occupancy) model of one or more occupants of the indoor space(s) 520, e.g., a respective probability of each indoor space 520 being occupied (or occupied by each of multiple, different occupants). The control system 102 can build the behavioral model based on past and current occupancy data, e.g., user inputs and occupancy schedules received from the user controls 200, biometric data received from the user device(s) 210, and/or presence data received from presence sensors 130M. For example, the behavioral model can be a learned model, e.g., a machine learning model, that the control system 102 trains on the occupancy data to estimate occupancy and activities that generate heat and/or moisture such as cooking, and opening windows and doors.

Hence, the control system 102 can use the behavioral model to predict one or more of: (i) when the indoor space(s) 520 will be occupied and need to be comfortable; (ii) when and how much additional heating and humidity loads may occur when the indoor space(s) 520 become occupied; and (iii) changes in the thermal model due to changes in ventilation (e.g., exchanging air to the outdoor space 510) and circulation of air between the indoor space(s) 520. The control system 102 can use the behavioral model to differentiate and locate occupants in a home (e.g., using gait detection), as well as automatically adjust a set point schedule and/or control settings (e.g., maximum fan speed) to tradeoff between comfort and energy consumption, among other features.

In some implementations, the system model also includes a performance model (g) of the set of heat pumps 100. The control system 102 may have obtained, constructed, and/or modified the performance model based on, for example, engineering and laboratory data of the ODUs 110 and IDUs 120, and/or logged control and status information of the set of heat pumps 100. Mathematically, the performance model can be represented as:

pₙ=g(uₙ;φₙ). (2b)

The performance model characterizes a set of performance metrics (pₙ) of the set of heat pumps 100 at a given time step in response to a given control input for the set of heat pumps 100 at the given time step. In general, a set of performance metrics

$${p}_{n} = {\{ {p}_{n , j} \}}_{j = 1}^{N}$$

at a given time step can be further discretized into a respective set of performance metrics (p_{n,j}) for each heat pump 100 at the given time step. Moreover, a set of performance metrics p_{n,j}=(Q_{n,j},P_{n,j}) for a heat pump 100 at a given time step can include a net thermal energy transfer rate (Q_{n,j}) and a net power consumption (P_{n,j}) of the heat pump 100 at the given time step. The ratio of these metrics, that is, COP_{n,j}=|Q_{n,j}|/P_{n,j}, provides the coefficient of performance (COP) of the heat pump 100, characterizing the energy efficiency of the heat pump 100. As shown in Eq. (2b), the performance model is parameterized by a set of model parameters (φₙ) that are allowed to vary at each time step, e.g., according to the states of the spaces 510 and 520 at the time step φₙ=φ(xₙ, x_{n,a}), which accounts for multiplicative and/or additive disturbances to uₙ.

In some implementations, the system model further includes an output model (h) of the heat pump system 10 that, among other aspects, can be used by the control system 102 for cost function optimization towards a generic target. Mathematically, the output model can be represented concisely as yₙ=h(xₙ). The output model characterizes a system output of the heat pump system 10 at a given time step in response to a state of the indoor space(s) 520 at the given time step. In general, the system output of the heat pump system 10 includes one or more target (or dependent) variables that the heat pump system 10 is attempting to influence. For example, the system output can include the temperature, humidity, and/or occupancy of one or more of the indoor space(s) 520, e.g., such that output model provides a mapping from a higher dimensional state space to a lower dimensional state space. As another example, the output model can provide a mapping from the state of the indoor space(s) 520 to a generic target variable such as a respective “comfort level” of each of the indoor space(s) 520, e.g., defined as a specific weighted combination of the temperature and humidity of the indoor space 520. In general, any of multiple target variables can be chosen for the system output.

Using the system model when executing the model predictive control algorithm, the control system 102 can minimize the energy consumption or energy costs associated with heating, cooling, and humidity control, while meeting the comfort requirements of the occupants, given the heat pump system 10 capabilities and limitations. Particularly, the control system 102 can compute the optimal operation of the heat pump system 10 to estimate the current state of the heat pump system 10; predict the future state of the heat pump system 10; account for constraints such as setpoint schedules and safety requirements (e.g., to prevent the home from freezing or becoming too humid even when unoccupied); and utilize a cost function that weighs energy use and cost against soft comfort constraints such as small temperature deviations, air flow speed, and noise level. As described in more detail below, the cost function generally encompasses a set of possible futures by taking into account, for example, the statistical nature of some of the aspects influencing operation of the heat pump system 10, such as predicted occupancy and weather forecasts.

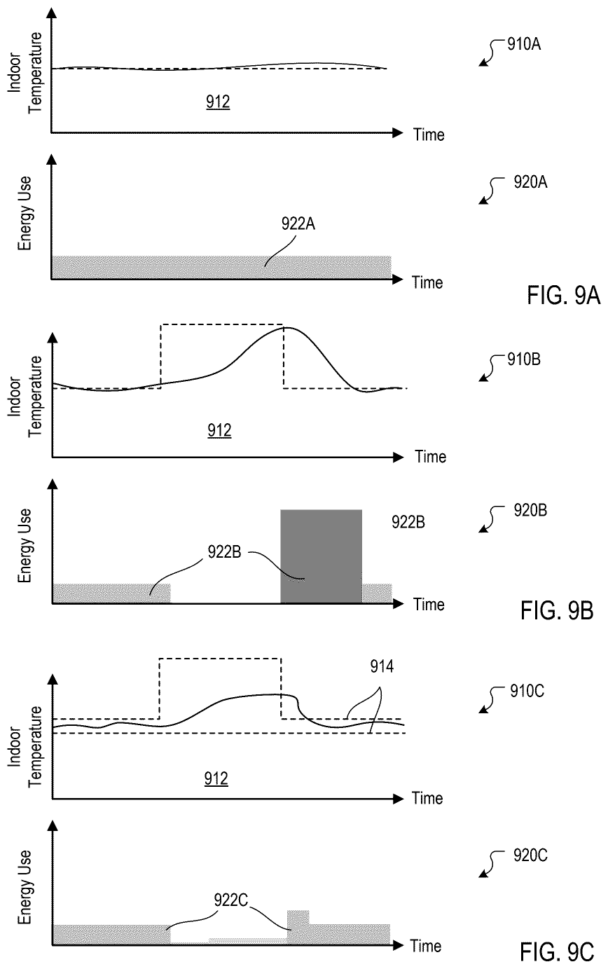

For example, a wide allowable temperature range for unoccupied spaces 520 affords the control system 102 the freedom to let the temperature drift substantially, but using the available models, the control system 102 can choose not to drift the temperature so much that inefficient high-power operation is involved to bring the unoccupied space 520 back to a comfortable temperature when occupied. To accomplish this, the control system 102 can predict when an unoccupied space 520 will again be occupied and, using the system model, determines the optimal temperature setback profile over time that realizes maximum energy savings for unoccupied spaces 520 while still efficiently preconditioning the space 520 at the appropriate time in anticipation of occupancy (see FIGS. 9A-9C for example).

Particularly, at each time step (t), the control system 102 performs the following processes (804)-(814):

The control system 102 receives (e.g., samples), from the sensors 130, the status information (sₙ) at the current time step (804). Note, a sample (sₙ) of status information can include status information collected by some, or all, of the sensors 130 of the heat pump system 10 at the current time step. Hence, the status information at the current time step can include data characterizing the state of the indoor space(s) 520, the state of the outdoor space 510, and the state of the set of heat pumps 100 at the current time step.

The control system 102 determines, from the status information at the current time step, a state (\hat{x}ₙ) of the indoor space(s) 520 at the current time step (806), e.g., as an estimate, observation, and/or measurement of the state of the indoor space(s) 520 at the current time step. In a similar vein, the control system 102 can also determine a state (\hat{x}_{n,a}) of the outdoor space 510 and/or the set of heat pumps 100 at the current time step from the status information at the current time step.

The control system 102 then predicts, using the thermal model, a respective state (xₙ₊ₖ₊₁) of the indoor space(s) 520 at each of one or more future time steps in response to: (i) the state (xₙ) of the indoor space(s) 520 at the current time step, and (ii) a respective given control input (uₙ₊ₖ) for the set of heat pumps 100 at each of the current and future time steps (808). Starting from the current states of the spaces 510 and 520, that is, for the initializations xₙ=\hat{x}ₙ and x_{n,a}=\hat{x}_{n,a}, the process (808) can be represented mathematically by the recursive formula:

xₙ₊ₖ₊₁=f(xₙ₊ₖ,uₙ₊ₖ;θₙ₊ₖ). (3a)

In other words, to predict the state of the indoor space(s) 520 at each future time step, the control system 102 is configured to: (i) receive an input including the state of the indoor space(s) 520 and given control input for the set of heat pumps 100 at the preceding time step; and (ii) process the input using the thermal model, in accordance with the set of model parameters of thermal model at the preceding time step, to generate the state of the indoor space(s) 520 at the future time step.

As shown in Eq. (3a), the control system 102 uses the current and predicted, future values of the thermal model's parameters (θₙ₊ₖ) when optimizing for time steps n+k. Here, k=0, 1, . . . , K−1 defines a prediction horizon over the current k=0 and future k>0 time steps, and K≥2 corresponds to a terminal future time step. For example, using a weather forecast

$${x}_{a}^{′} ( \cdot )$$

including a respective predicted state

$$( {x}_{n , a}^{′} )$$

of the outdoor space 510 at each time step, the control system 102 can predict (or update) the thermal model's parameters

$${θ}_{n + k} = θ ( {x}_{n + k , a}^{′} )$$

for each of the future time step(s).

The control system 102 can perform a similar procedure using the performance model. Particularly, the control system 102 can predict, using the performance model, a respective set of performance metrics (Pₙ₊ₖ) of the set of heat pumps 100 at each of the current and future time steps in response to the respective given control input at the current or future time step. This process can be represented mathematically as:

Pₙ₊ₖ=g(uₙ₊ₖ;φₙ₊ₖ). (3b)

In other words, to predict the set of performance metrics of the set of heat pumps 100 at each of the current and future time steps, the control system 102 is configured to: (i) receive an input including the given control input for the set of heat pumps 100 at the current or future time step; and (ii) process the input using the performance model, in accordance with the set of model parameters of the set of heat pumps 100 at the current or future time step, to generate the set of performance metrics of the set of heat pumps 100 at the current or future time step.

As shown in Eq. (3b), the control system 102 uses the current and predicted, future values (φₙ₊ₖ) of the performance model's parameters when optimizing over the prediction horizon. For example, from the thermal model and a weather forecast, the control system 102 can use the predicted states of the spaces 510 and 520 to predict (or update) the performance model's parameters

$${φ}_{n + k} = φ ( {x}_{n + k} , {x}_{n + k , a}^{′} )$$

for each of the future time step(s).

The control system 102 then generates a cost function (J) that depends on the states of the indoor space(s) 520 and given control inputs at each of the current and future time steps (810). The process (810) can be represented mathematically as:

$$J ( K , {\hat{x}}_{n} , {u}_{n} ( \cdot ) ) = {F}_{n} ( {x}_{n + k} ) + {\sum }_{k = 0}^{K - 1} {L}_{n , k} ( {x}_{n + k} , {u}_{n + k} ) , \qquad ( 4 a )$$

where uₙ(⋅)={uₙ, uₙ₊₁, . . . , u_{n+K-1}}defines a given control sequence over the prediction horizon that includes the respective given control input at each of the current and future time steps.

As shown in Eq. (4a), the cost function includes, for each of the current and future time steps, a respective cost term (L_{n,k}) that depends on the respective state of the indoor space(s) 520 and given control input at the current or future time step. Here, the cost function further includes a terminal cost term (Fₙ) that depends on the state of the indoor space(s) 520 at the terminal future time step. In general, the control system 102 uses the cost function to appropriately weigh the confounding factors influencing performance, efficiency, comfort, schedules, constraints, and other parameters applied to the heat pump system 10.

In some implementations, the control system 102 splits the dependency of each cost term as:

L_{n,k}(xₙ₊ₖ,uₙ₊ₖ)−L_{n,k,1}(xₙ₊ₖ)+L_{n,k,2}(uₙ₊ₖ). (4b)

Here, each cost term includes: (i) a respective first cost term (L_{n,k,1}) that depends on the respective state of the indoor space(s) 520 at the current or future time step, and (ii) a respective second cost term (L_{n,k,2}) that depends on the respective given control input at the current or future time step.

For example, the control system 102 can follow a temperature, humidity, and/or occupancy schedule by obtaining a reference state trajectory

$${x}^{′} ( \cdot ) = \{ {x}_{0}^{′} , {x}_{1}^{′} , {x}_{2}^{′} … \}$$

that includes one or more of the temperature, humidity, or occupancy schedules. In other words, the reference state trajectory includes a respective reference state

$$( {x}_{n}^{′} )$$

of the indoor space(s) 520 at each time step. Each reference state

$${x}_{n}^{′} = ( {T}_{n}^{′} , {H}_{n}^{′} , {O}_{n}^{′} )$$

can include a respective set of setpoint temperatures

$$( {T}_{n}^{′} ) ,$$

setpoint humidities

$$( {H}_{n}^{′} ) ,$$

and/or expected occupancies

$$( {O}_{n}^{′} )$$

of the indoor space(s) 520, e.g., as specified by one or more user inputs via the user controls 200. Each first cost term can then be represented mathematically as:

$${L}_{n , k , 1} ( {x}_{n + k} ) = {L}_{1} ( {x}_{n + k} , {x}_{n + k}^{′} ) . \qquad ( 4 c )$$

As shown in Eq. (4c), each first cost term includes a respective error (L₁) between: (i) the respective state of the indoor space(s) 520, and (ii) the respective reference state of the indoor space(s) 520, at the current or future time step. For example, the error can be a mean-squared error, an absolute error, a weighed error, or other appropriate error metric.

Alternatively, or in addition, the control system 102 can use each second cost term to follow a reference control sequence u′(⋅) including a respective reference control input

$$( {u}_{n}^{′} )$$

for the set of heat pumps 100 at each time step, e.g., as specified by a user input via the user controls 200. Each second cost term can then be represented mathematically as:

$${L}_{n , k , 2} ( {u}_{n + k} ) = {L}_{2} ( {u}_{n + k} , {u}_{n + k}^{′} ) . \qquad ( 4 d )$$

As shown in Eq. (4d), each second cost term includes a respective error (L₂) between: (i) the respective given control input, and (ii) the respective reference control input, at the current or future time step. For example, similar to above, the error can be a mean-squared error, an absolute error, a weighed error, or other appropriate error metric.

In some implementations, the cost function also depends on the sets of performance metrics of the set heat pumps 100 at each of the current and future time steps, e.g., to maximize for efficiency and/or energy cost of the heat pump system 10.

As one example, the control system 102 can modify each cost term in the cost function by multiplying it with the respective coefficient of performance of each heat pump 100 at the current or future time step L_{n,k}→L_{n,k} Πⱼη_{n+k,j}, where η_{n+k,j}=COP_{max,j}−COP_{n+k,j} is the difference between the coefficient of performance of the heat pump 100 at the current or future time step and the theoretical maximum efficiency (COP_{max,j}) of the heat pump 100, e.g., the Carnot efficiency. In this case, the coefficients of performance provide a weighting to the cost terms that emphasizes energy efficiency when the control system 102 minimizes the cost function over the prediction horizon.

Moreover, the difference between the total thermal energy transfer rate of the set of heat pumps 100 to the theoretical maximum thermal energy transfer rate at a time step is ΔQₙ₊ₖ=ΣⱼP_{n+k,j}η_{n+k,j}=Σⱼ(P_{n+k,j}COP_{max,j}−|Q_{n+k,j}|). Along similar lines, the difference between the total thermal energy transferred by the set of heat pumps 100 to the theoretical maximum at the time step is then ΔQₙ₊ₖΔtₙ₊ₖ, where Δtₙ₊ₖ−tₙ₊ₖ+1−tₙ₊ₖ is the length of the time step. Here, the cost function can further include, for each of the current and future time steps, a respective thermal energy cost term (ΔQₙ₊ₖΔtₙ₊ₖ) that depends on the respective set of performance metrics of each heat pump 100 at the current or future time step. In this case, the control system 102 aims to maximize the thermal energy produced by the set of heat pumps 100 over the prediction horizon.

As another example, using a peak pricing schedule ψ(⋅) including a respective predicted price of energy (ψₙ) at each time step, the control system 102 can minimize a predicted energy cost of the set of heat pumps 100 over the prediction horizon. Particularly, the control system 102 can multiply the predicted net power consumptions of the set of heat pump 100 with the predicted price of energy to obtain the total energy cost rate Cₙ₊ₖ=ψₙ₊ₖΣⱼP_{n+k,j} at a time step. Along similar lines, the total energy cost at the time step is then Cₙ₊ₖΔtₙ₊ₖ. Here, the cost function can further include, for each of the current and future time steps, a respective energy cost term (Cₙ₊ₖΔtₙ₊ₖ) that depends on the respective power consumption of each heat pump 100 and the respective predicted price of energy at the current or future time step.

In some implementations, the control system 102 uses the output model for cost function optimization. Particularly, the control system 102 can predict, using the output model, a respective system output (yₙ₊ₖ) of the heat pump system 10 at each of the current and future time steps in response to the respective state of the indoor space(s) 520 at the current or future time step. Again, this can be represented mathematically as yₙ₊ₖ=h(xₙ₊ₖ).

The control system 102 can obtain, e.g., by receiving via the user controls 200 or retrieving from memory 52, a reference system trajectory

$${y}^{′} ( \cdot ) = \{ {y}_{0}^{′} , {y}_{1}^{′} , {y}_{2}^{′} … \}$$

including a respective reference system output (yₙ′) of the heat pump system 10 at each time step. The cost function can then include terms that measure an error between the system outputs and reference systems outputs over the prediction horizon:

$$J ( K , {\hat{x}}_{n} , {u}_{n} ( \cdot ) ) = {\sum }_{k = 0}^{K} L ( {y}_{n + k} , {y}_{n + k}^{′} ) . \qquad ( 4 e )$$

As shown in Eq. (4e), the cost function includes, for each of the current and future time steps, a respective error (L) between: (i) the respective system output of the heat pump system 10, and (ii) the respective reference system output of the heat pump system 10, at the current or future time step. For example, similar to above, the error can be a mean-squared error, an absolute error, a weighed error, or other appropriate error metric. Here, Eq. (4e) also includes an error (e.g., a terminal error) between the system output and the reference system output of the heat pump system 10 at the terminal future time step.

After generating a suitable cost function, the control system 102 then minimizes the cost function with respect to the given control inputs at each of the current and future time steps (812). The process (812) can be represented mathematically as:

$${u}_{n}^{*} ( \cdot ) = arg {min}_{{u}_{n} ( \cdot )} J ( K , {\hat{x}}_{n} , {u}_{n} ( \cdot ) ) \qquad ( 5 )$$

Eq. (5) results in an optimal control sequence

$${u}_{n}^{*} ( \cdot ) = \{ {u}_{n}^{*} , {u}_{n + 1}^{*} , … , {u}_{n + K - 1}^{*} \}$$

over the prediction horizon that includes a respective optimal control input at each of the current and future time steps. The control system 102 can use various optimization techniques to minimize the cost function, e.g., stochastic gradient descent (SGD) methods with a particular learning rate and/or weight decay, e.g., AdaGrad, Implicit Updates, AdamW, Momentum, among others.

Moreover, to implement one or more constraints on the heat pump system 10, e.g., as specified by one or more user inputs via the user controls 200, the control system 102 can minimize the cost function while subject to one or more of: (i) a respective temperature bound T_{min,i}≤T_{n+k,i}≤T_{max,i} for each indoor space 520, (ii) a respective humidity bound H_{min,i}≤H_{n+k,i}≤H_{max,i} for each indoor space 520, (iii) a respective temperature fluctuation bound |T_{n+k,i}−T_{n+k+1,i}|≤ΔTᵢ for each indoor space 520, (iv) a respective humidity fluctuation bound |H_{n+k,i}−H_{n+k+1,i}|≤ΔHᵢ for each indoor space 520, (v) a respective control input bound u_{min,j}≤u_{n+k,j}≤u_{max,j} for each heat pump 100, (vi) a respective control input fluctuation bound |u_{n+k,j}−u_{n+k+1,j}|≤Δuⱼ for each heat pump 100, (vii) a respective power consumption bound P_{n+k,j}≤P_{max,j} for each heat pump 100, (viii) a total energy cost rate bound Cₙ₊ₖ≤Cₘₐₓ for the set of heat pumps 100, and (ix) a total equivalent carbon dioxide (CO₂) output rate bound of the set of heat pumps 100.

The control system 102 can also determine an optimal state trajectory

$${x}_{n}^{*} ( \cdot )$$

over the prediction horizon by inserting the optimal control inputs at each of the current and future time steps into the thermal model:

$${x}_{n + k + 1}^{*} = f ( {x}_{n + k}^{*} , {u}_{n + k}^{*} ; {θ}_{n + k} ) , \qquad ( 6 )$$

where

$${x}_{n}^{*} ( \cdot ) = \{ {x}_{n} , {x}_{n + 1}^{*} , … , {x}_{n + K}^{*} \}$$

includes a respective optimal state of the indoor space(s) 520 at each of the current, future, and terminal future time steps. Similarly, the control system 102 can determine an optimal performance trajectory

$${p}_{n}^{*} ( \cdot ) = \{ {p}_{n + 1}^{*} , {p}_{n + 1}^{*} , … , {p}_{n + K - 1}^{*} \}$$

and an optimal system trajectory

$${y}_{n}^{*} ( \cdot ) = \{ {y}_{n} , {y}_{n + 1}^{*} , … , {y}_{n + K}^{*} \}$$

over the prediction horizon by inserting the optimal states and optimal control inputs over the prediction horizon into the performance and output models, respectively.

The control system 102 transmits, to the set of heat pumps 100, the optimal control input

$$( {u}_{n}^{*} )$$

at the current time step (814).

The control system 102 then repeats processes (804)-(814) at the next time step tₙ₊₁, and the next time step tₙ₊₂, and so on.

FIGS. 9A-9C include plots depicting indoor temperature of an indoor space and energy usage versus time for different heat pump control sequences when the indoor space is unoccupied for an away period 912.

FIG. 9A includes plots 910A and 920A of indoor temperature and energy usage, respectively, versus time for a control sequence that uses a constant but nonoptimal amount of energy 922A over the control sequence, including the away period 912.

FIG. 9B includes plots 910B and 920B of indoor temperature and energy usage, respectively, versus time for a control sequence that uses a variable but still nonoptimal amount of energy 922B over the control sequence. Particularly, the control sequence turns the heat pump off during the away period 912, e.g., based on a temperature schedule for the indoor space 520. This may save energy during the away period 912, but the energy savings are undone because of aggressive inefficient reconditioning when the schedule (or a user) sets a temperature setpoint back to a comfortable level.

FIG. 9C includes plots 910C and 920C of indoor temperature and energy usage, respectively, versus time for a control sequence, e.g., an optimal control sequence computed by the control system 102, that uses a variable and optimal (i.e., least) amount of energy 922C over the control sequence. Here, the control sequence instructs the heat pump to provide a small amount of cooling (e.g., preconditioning) to the indoor space during the away period 912, as well as allowing the indoor temperature to swing slightly within a control band 914.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A heat pump system, comprising:
a heat pump configured to transfer thermal energy to or from a space in accordance with a respective control input at each of a plurality of time steps;
a plurality of sensors configured to collect status information of the space over the plurality of time steps; and
a control system communicatively coupled with the heat pump and the plurality of sensors, wherein the control system is configured to:
obtain a system model comprising a thermal model of the space,
wherein the thermal model characterizes a state of the space at a sequential time step in response to: (i) a state of the space at a given time step, and (ii) a given control input for the heat pump at the given time step; and
at each of the plurality of time steps:
receive, from the plurality of sensors, the status information at a current time step;
determine, from the status information at the current time step, a state of the space at the current time step;
predict, using the thermal model, a respective state of the space at each of one or more future time steps in response to: (i) the state of the space at the current time step, and (ii) a respective given control input for the heat pump at each of the current and future time steps;
generate a cost function that depends on the states of the space and given control inputs at each of the current and future time steps;
minimize the cost function with respect to the given control inputs at each of the current and future time steps to determine the control input at the current time step; and
transmit, to the heat pump, the control input at the current time step.

2. The heat pump system of claim 1, wherein:
the control system is further configured to receive a reference state trajectory comprising a respective reference state of the space for each of the plurality of time steps, and
at each of the plurality of time steps, the cost function comprises, for each of the current and future time steps, a respective error between: (i) the respective state of the space, and (ii) the respective reference state of the space, at the current or future time step.

3. The heat pump system of claim 2, wherein the reference state trajectory comprises one or more of:
a temperature schedule comprising a respective setpoint temperature of the space for each of the plurality of time steps;
a humidity schedule comprising a respective setpoint humidity of the space for each of the plurality of time steps; or
an occupancy schedule comprising a respective expected occupancy of the space for each of the plurality of time steps.

4. The heat pump system of claim 1, wherein:
the control system is further configured to receive a reference control sequence comprising a respective reference control input for each of the plurality of time steps, and
at each of the plurality of time steps, the cost function comprises, for each of the current and future time steps, a respective error between: (i) the respective given control input, and (ii) the respective reference control input, at the current or future time step.

5. The heat pump system of claim 1, wherein at each of the plurality of time steps, the cost function further comprises a terminal cost term that depends on the state of the space at a terminal future time step.

6. The heat pump system of claim 1, wherein the plurality of sensors comprises:
a temperature sensor configured to collect status information characterizing a temperature of the space;
a humidity sensor configured to collect status information characterizing a humidity of the space; and
a presence sensor configured to collect status information characterizing an occupancy of the space.

7. The heat pump of claim 6, wherein the presence sensor is a millimeter-wave (mmWave) sensor, a thermal imaging sensor, a passive infrared (PIR) sensor, a light detection and ranging (LIDAR) sensor, a carbon dioxide (CO₂) sensor, a window sensor, a door sensor, or a connected Internet of things (IoT) sensor.

8. The heat pump system of claim 1, wherein:
the space is an indoor space,
the heat pump is configured to transfer thermal energy between the indoor space and an outdoor space in accordance with the respective control input at each of the plurality of time steps,
the plurality of sensors is further configured to collect status information of the outdoor space over the plurality of time steps, and
the control system is further configured to, at each of the plurality of time steps:
determine, from the status information at the current time step, a state of the outdoor space at the current time step; and
update a set of model parameters of the thermal model at the current time step based on the state of the outdoor space at the current time step.

9. The heat pump system of claim 8, wherein the plurality of sensors comprises:
a temperature sensor configured to collect status information characterizing an ambient temperature of the outdoor space; and
a humidity sensor configured to collect status information characterizing an ambient humidity of the outdoor space.

10. The heat pump system of claim 8, wherein the control system is further configured to:
receive a weather forecast comprising a respective predicted state of the outdoor space for each of the plurality of time steps; and
predict a respective set of model parameters of the thermal model for each of the plurality of time steps based on the respective predicted state of the outdoor space at the time step.

11. The heat pump system of claim 8, wherein:
the heat pump is configured to circulate a working fluid in a thermodynamic cycle, the heat pump comprising:
a variable-speed compressor configured to compress the working fluid;
an indoor heat exchanger configured to transfer thermal energy between the working fluid and the indoor space; and
an outdoor heat exchanger configured to transfer thermal energy between the working fluid and the outdoor space, and
the respective control input comprises, at each of the plurality of time steps:
a respective speed of the compressor at the time step;
a respective speed of a fan of the indoor heat exchanger at the time step; and
a respective speed of a fan of the outdoor heat exchanger at the time step.

12. The heat pump system of claim 11, wherein the working fluid is a refrigerant, and the thermodynamic cycle is a vapor-compression cycle.

13. The heat pump system of claim 11, wherein:
the heat pump further comprises:
an electronic expansion valve configured to expand the working fluid; and
a reversing valve configured to reverse a direction of the working fluid circulating in the heat pump, and
the respective control input further comprises, at each of the plurality of time steps:
a respective size of an opening of the electronic expansion valve at the time step; and
a respective energized or de-energized state of the reversing valve at the time step.

14. The heat pump system of claim 13, wherein the heat pump comprises:
an indoor unit housing the indoor heat exchanger and one or more of the plurality of sensors; and
an outdoor unit housing the compressor, outdoor heat exchanger, reversing valve, and one or more of the plurality of sensors.

15. The heat pump system of claim 14, wherein at least a portion of the control system is housed in the indoor unit, the outdoor unit, or both.

16. The heat pump system of claim 1, wherein:
the system model further comprises a performance model of the heat pump,
wherein the performance model characterizes a set of performance metrics of the heat pump at a given time step in response to a given control input for the heat pump at the given time step,
the control system is further configured to, at each of the plurality of time steps:
predict, using the performance model, a respective set of performance metrics of the heat pump at each of the current and future time steps in response to the respective given control input at the current or future time step, and
at each of the plurality of time steps, the cost function depends on the sets of performance metrics of the heat pump at each of the current and future time steps.

17. The heat pump system of claim 16, wherein:
a set of performance metrics of the heat pump at a given time step comprises: (i) a net thermal energy transfer rate of the heat pump, and (ii) a power consumption of the heat pump, at the given time step,
the control system is further configured to, at each of the plurality of time steps:
predict a respective coefficient of performance of the heat pump at each of the current and future time steps based on a ratio between: (i) the respective net thermal energy transfer rate of the heat pump, and (ii) the respective power consumption of the heat pump, at the current or future time step, and
at each of the plurality of time steps, the cost function depends on the coefficients of performance of the heat pump at each of the current and future time steps.

18. The heat pump system of claim 17, wherein:
the control system is further configured to receive a peak pricing schedule comprising a respective predicted price of energy for each of the plurality of time steps, and
at each of the plurality of time steps, the cost function comprises, for each of the current and future time steps, a respective energy cost term that depends on the respective power consumption of the heat pump multiplied by the respective predicted price of energy at the current or future time step.

19. A control system for a heat pump configured to transfer thermal energy to or from a space in accordance with a respective control input at each of a plurality of time steps, wherein the control system is configured to:
obtain a system model comprising a thermal model of the space,
wherein the thermal model characterizes a state of the space at a sequential time step in response to: (i) a state of the space at a given time step, and (ii) a given control input for the heat pump at the given time step; and
at each of the plurality of time steps:
receive, from a plurality of sensors configured to collect status information of the space over the plurality of time steps, the status information at a current time step;
determine, from the status information at the current time step, a state of the space at the current time step;
predict, using the thermal model, a respective state of the space at each of one or more future time steps in response to: (i) the state of the space at the current time step, and (ii) a respective given control input for the heat pump at each of the current and future time steps;
generate a cost function that depends on the states of the space and given control inputs at each of the current and future time steps;
minimize the cost function with respect to the given control inputs at each of the current and future time steps to determine the control input at the current time step; and
transmit, to the heat pump, the control input at the current time step.

20. A method performed by a control system for a heat pump configured to transfer thermal energy to or from a space in accordance with a respective control input at each of a plurality of time steps, the method comprising:
obtaining a system model comprising a thermal model of the space,
wherein the thermal model characterizes a state of the space at a sequential time step in response to: (i) a state of the space at a given time step, and (ii) a given control input for the heat pump at the given time step; and
at each of the plurality of time steps:
receiving, from a plurality of sensors configured to collect status information of the space over the plurality of time steps, the status information at a current time step;
determining, from the status information at the current time step, a state of the space at the current time step;
predicting, using the thermal model, a respective state of the space at each of one or more future time steps in response to: (i) the state of the space at the current time step, and (ii) a respective given control input for the heat pump at each of the current and future time steps;
generating a cost function that depends on the states of the space and given control inputs at each of the current and future time steps;
minimizing the cost function with respect to the given control inputs at each of the current and future time steps to determine the control input at the current time step; and
transmitting, to the heat pump, the control input at the current time step.
